(19) United States
(12) Patent Application Publication
(10) Pub. No.: US 2010/0073806 A1
(43) Pub. Date: Mar. 25, 2010

(54) Magnetic recording head and magnetic recording apparatus

(75) Inventors: Katsuhiko Koui, Yokohama-Shi (JP); Hitoshi Iwasaki, Yokosuka-Shi (JP); Masayuki Takagishi, Tokyo (JP); Kenichiro Yamada, Tokyo (JP); Tomomi Funayama, Tokyo (JP); Masahiro Takashita, Yokohama-Shi (JP); Mariko Shimizu, Yokohama-Shi (JP); Soichi Oikawa, Tokyo (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/585,459

(22) Filed: Sep. 15, 2009

(30) Foreign Application Priority Data
Sep. 25, 2008 (JP) 2008-246146

(51) Int. Cl. G11B 21/02; G11B 5/127

(52) U.S. Cl. 360/75; 360/110; G9B/5.104

(57) ABSTRACT

It is made possible to improve the recording resolution. A magnetic recording head includes: a magnetic pole that has a first magnetic portion including an air bearing surface, and generates a write magnetic field; and a spin torque oscillator that is formed on the air bearing surface of the magnetic pole, and is formed with a stack structure including a first magnetic layer, a second magnetic layer, and a nonmagnetic layer interposed between the first magnetic layer and the second magnetic layer, the second magnetic layer generating a high-frequency magnetic field when current is applied between the first magnetic layer and the second magnetic layer.

### CROSS-REFERENCE TO RELATED APPLICATION

This application is based upon and claims the benefit of priority from prior Japanese Patent Application No. 2008-246146 filed on Sep. 25, 2008 in Japan, the entire contents of which are incorporated herein by reference.

### BACKGROUND OF THE INVENTION

1. Field of the Invention

The present invention relates to a magnetic recording head and a magnetic recording apparatus.

2. Related Art

In 1990's, there were dramatic increases in the recording density and recording capacity of HDDs (Hard Disk Drives), as MR (Magneto-Resistive effect) heads and GMR (Giant Magneto-Resistive effect) heads were put into practical use. However, the recording density increase rate temporarily became lower in the beginning of the 2000's, since the problem of heat fluctuations of magnetic recording media rose up to the surface. Recently, the HDD recording density has been increasing about 40% per annum, as the vertical magnetic recording that was more suitable for high-density recording in principle than horizontal magnetic recording was put into practical use in 2005.

In the latest recording density demonstration experiment, a higher level than the 400 Gbits/inch² level has been reached. If the progress continues at this rate, recording density of 1 Tbits/inch² is expected to be reached around the year 2012. However, achieving such high recording density is considered not easy even by a vertical magnetic recording method, as the problem of heat fluctuations will surface again.

As a recording method to solve the above problem, a “high-frequency field assist recording method” has been suggested. By the high-frequency field assist recording method, a high-frequency magnetic field that is much higher than the recording signal frequency and is close to the resonance frequency of the magnetic recording medium is locally induced. As a result, the magnetic recording medium resonates, and the coercive force Hc of the magnetic recording medium having the high-frequency magnetic field induced therein is made equal to or less than half the initial coercive force. Therefore, by overlapping the recording magnetic field with the high-frequency magnetic field, magnetic recording can be performed on a magnetic recording medium that has much higher coercive force Hc and much greater magnetic anisotropic energy Ku (see U.S. Pat. No. 6,011,664, for example). By the technique disclosed in the U.S. Pat. No. 6,011,664, however, the high-frequency magnetic field is generated from a coil, and it is difficult to efficiently induce the high-frequency magnetic field at the time of high-density recording.

As a technique for generating a high-frequency magnetic field, a technique that involves a spin torque oscillator has been suggested (see United States Patent Application Publication No. 2008/0019040, for example). According to the techniques disclosed in United States Patent Application Laid-Open No. 2008/0019040, the spin torque oscillator includes a spin injection layer, a nonmagnetic layer, a magnetic layer, and a pair of electrode layers that sandwich those layers. When a direct current flows into the spin torque oscillator through the pair of electrode layers, the magnetization of the magnetic layer ferromagnetically resonates by virtue of the spin torque generated from the spin injection layer. As a result, a high-frequency magnetic field is generated from the spin torque oscillator.

In the high-frequency assist recording head disclosed in United States Patent Application Publication No. 2008/0019040, however, the main magnetic pole and the spin torque oscillator are spatially deviated from the linear recording direction. As a result, the intensity peak position of the high-frequency magnetic field generated from the spin torque oscillator does not match the intensity peak position of the magnetic field generated under the main magnetic pole. In this case, the position at which the recording capacity becomes largest does not match the position at which the assistance effect becomes largest in the linear recording direction. As a result, the recording intensity varies in the linear recording direction, and the recording resolution becomes poorer. For those reasons, there has been the problem that increasing the linear recording density is difficult while the writing capacity is improved.

### SUMMARY OF THE INVENTION

The present invention has been made in view of these circumstances, and an object thereof is to provide a magnetic recording head and a magnetic recording apparatus that can improve the recording resolution.

A magnetic recording head according to a first aspect of the present invention includes: a magnetic pole that has a first magnetic portion including an air bearing surface, and generates a write magnetic field; and a spin torque oscillator that is formed on the air bearing surface of the magnetic pole, and is formed with a stack structure including a first magnetic layer, a second magnetic layer, and a nonmagnetic layer interposed between the first magnetic layer and the second magnetic layer, the second magnetic layer generating a high-frequency magnetic field when current is applied between the first magnetic layer and the second magnetic layer.

A magnetic recording apparatus according to a second aspect of the present invention includes: a magnetic recording medium; the magnetic recording head according to the first aspect; a reproducing unit that reads a signal recorded on the magnetic recording medium; a movement control unit that controls the magnetic recording medium, the magnetic recording head, and the reproducing unit to relatively move while the magnetic recording medium faces the magnetic recording head and the reproducing unit in a floating or contact state; a position control unit that controls the magnetic recording head to be located at a predetermined recording position on the magnetic recording medium; and a signal processing unit that performs processing on a signal for writing on the magnetic recording medium and a signal for reading from the magnetic recording medium, using the magnetic head.

### BRIEF DESCRIPTION OF THE DRAWINGS

FIG. 1 is a cross-sectional view of a magnetic recording head in accordance with a first embodiment;

FIG. 2 is a plan view of the magnetic recording head of the first embodiment, seen from the medium side;

FIG. 3 is a diagram for explaining the movements of magnetization and a magnetic field when the magnetization of a recording bit of a medium is reversed by a recording head;

FIGS. 4(a) and 4(b) are diagrams for explaining the effects of the magnetic recording head of the first embodiment;

FIGS. 5(a) and 5(b) are diagrams for explaining the positional relationship between the magnetic field and a high-frequency magnetic field;

FIG. 6 is a cross-sectional view of a magnetic recording head in accordance with a second embodiment;

FIG. 7 is a plan view of the magnetic recording head of the second embodiment, seen from the medium side;

FIG. 8 is a cross-sectional view of a magnetic recording head in accordance with a third embodiment;

FIG. 9 is a plan view of the magnetic recording head of the third embodiment, seen from the medium side;

FIG. 10 is a cross-sectional view of a magnetic recording head in accordance with a fourth embodiment;

FIG. 11 is a cross-sectional view of a magnetic recording head in accordance with a fifth embodiment;

FIG. 12 is a plan view of the magnetic recording head of the fifth embodiment, seen from the medium side;

FIG. 13 is a cross-sectional view of a magnetic recording head in accordance with a sixth embodiment;

FIG. 14 is a cross-sectional view of a magnetic recording head in accordance with a seventh embodiment;

FIG. 15 is a plan view of the magnetic recording head of the seventh embodiment, seen from the medium side;

FIG. 16 is a cross-sectional view of a magnetic recording head in accordance with an eighth embodiment;

FIG. 17 is a cross-sectional view of a magnetic recording head in accordance with a ninth embodiment;

FIG. 18 is a cross-sectional view of a magnetic recording head in accordance with a tenth embodiment;

FIG. 19 is a cross-sectional view of a magnetic head in accordance with an eleventh embodiment;

FIG. 20 is a diagram for explaining the effects of the magnetic head of the eleventh embodiment;

FIGS. 21(a) and 21(b) are diagrams for explaining a method for manufacturing a magnetic head in accordance with a twelfth embodiment;

FIG. 22 is a diagram for explaining the method for manufacturing the magnetic head in accordance with the twelfth embodiment;

FIG. 23 is a diagram for explaining the method for manufacturing the magnetic head in accordance with the twelfth embodiment;

FIGS. 24(a) and 24(b) are diagrams for explaining the method for manufacturing the magnetic head in accordance with the twelfth embodiment;

FIGS. 25(a) and 25(b) are diagrams for explaining the method for manufacturing the magnetic head in accordance with the twelfth embodiment;

FIG. 26 is a perspective view schematically showing the structure of a magnetic recording apparatus in accordance with a thirteenth embodiment;

FIG. 27 is a perspective view showing a head stack assembly having a head slider mounted thereon;

FIGS. 28(a) and 28(b) are views illustrating a first specific example of a magnetic recording medium; and

FIGS. 29(a) and 29(b) are views illustrating a second specific example of a magnetic recording medium.

### DETAILED DESCRIPTION OF THE INVENTION

The following is a description of embodiments of the present invention, with reference to the accompanying drawings.

The drawings are schematic or conceptual, and the relationship between the thickness and the width of each component, and the size ratios between the components shown in the drawings are not necessarily the same as those in practice. Also, the sizes and ratios between the components might vary between the drawings.

In this specification and the accompanying drawings, like components are denoted by like reference numerals, and the same explanation will not be repeated when appropriate.

### First Embodiment

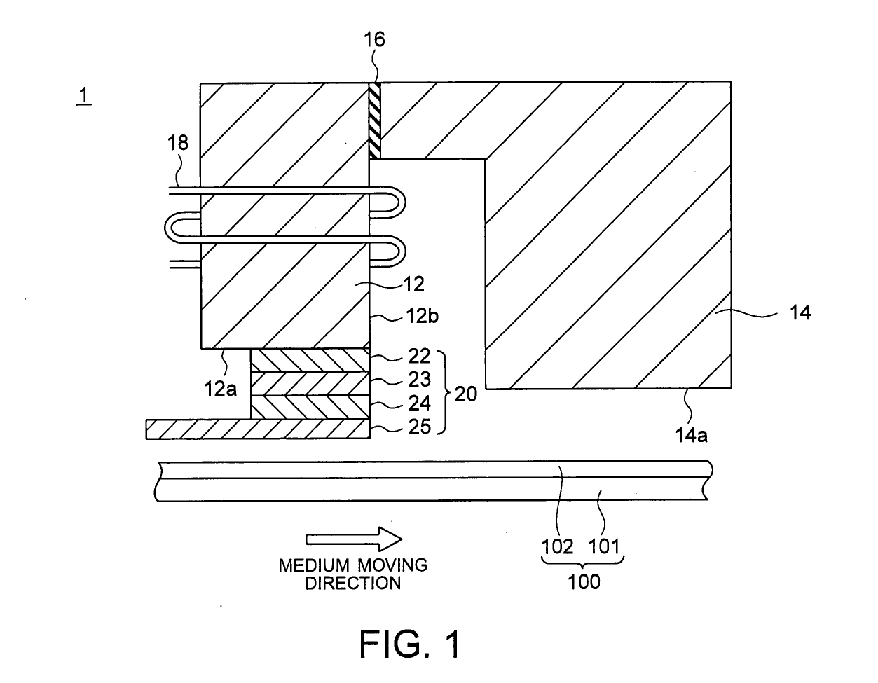

FIG. 1 shows a high-frequency assist magnetic recording head in accordance with a first embodiment of the present invention. In FIG. 1, the magnetic recording medium 100 is shown so as to clearly indicate the positional relationship between the magnetic recording medium 100 and the magnetic recording head 1 of this embodiment in operation, and the magnetic recording head 1 does not include the magnetic recording medium 100 in its structure. FIG. 1 is a cross-sectional view of the magnetic recording head 1 of this embodiment, taken along a plane parallel to the medium moving direction or the linear recording direction and perpendicular to the medium surface.

The magnetic recording head 1 of this embodiment includes a main magnetic pole 12, a return yoke 14, a coil 18, and a spin torque oscillator 20. The main magnetic pole 12 has a face (an air bearing surface (also referred to as the ABS) 12a facing the medium 100. The main magnetic pole 12 is magnetically connected to the return yoke 14 via an insulating film 16, on the opposite side from the air bearing surface 12a or on the further side from the medium 100. Accordingly, the main magnetic pole 12 and the return yoke 14 are magnetically connected to each other via the insulating film 16, but are electrically insulated from each other. In this embodiment, the insulating film 16 may not be provided, but is necessary in the later described second embodiment. The return yoke 14 is provided in the medium moving direction with respect to the main magnetic pole 12. The coil 18 for inducing a magnetic field into the main magnetic pole 12 is provided at the upper portion of the main magnetic pole 12. The medium 100 used in this embodiment has a perpendicular magnetic recording layer 102 formed on a backing layer 101.

The spin torque oscillator 20 is provided on the air bearing surface 12a of the main magnetic pole 12. The spin torque oscillator 20 includes a spin injection layer 22, a nonmagnetic intermediate layer 23, an oscillation layer 24, and a lower electrode 25. The spin injection layer 22 is in contact with the air bearing surface 12a of the main magnetic pole 12. The nonmagnetic intermediate layer 23 is in contact with the spin injection layer 22. The oscillation layer 24 is in contact with the nonmagnetic intermediate layer 23. The lower electrode 25 is in contact with the oscillation layer 24. Accordingly, the lower electrode 25 of the spin torque oscillator 20 is located closest to the medium 100, and the spin injection layer 22 is located furthest from the spin injection layer 22 in this embodiment.

When current flows between the main magnetic pole 12 and the lower electrode 25, the spin torque oscillator 20 is activated. The main magnetic pole 12 also serves as the upper electrode of the spin torque oscillator 20.

The main magnetic pole 12 is a ferromagnetic pole that generates a magnetic field for magnetic recording, and the magnetic field is normally generated from the air bearing surface 12a toward the medium 100. Although not shown in FIG. 1, the magnetic field generated from the main magnetic pole 12 is induced by the coil 18 provided at the upper portion of the main magnetic pole 12 when seen from the air bearing surface 12a, and the direction of the magnetic field can be controlled by adjusting the direction of the current flowing in the coil 18. By changing the direction of the magnetic field, upward field bits and downward field bits can be written on the medium 100. Also, the main magnetic pole 12 serves as an electrode that energizes the spin torque oscillator 20 in a direction perpendicular to the film plane.

The spin injection layer 22 is a ferromagnetic material that serves to inject polarized spins into the oscillation layer 24. The oscillation layer 24 oscillates with respect to the magnetization direction of the spin injection layer 22, so as to generate a high-frequency magnetic field. Accordingly, the oscillation layer 24 should be designed to have a fixed magnetization direction while having spin torque oscillations. Otherwise, the oscillation layer 24 stops functioning. More specifically, the oscillation layer 24 should be made of a hard magnetic material, so as to have stable characteristics.

Meanwhile, when a writing operation is performed, a magnetic field is received from the main magnetic pole 12. In a case where the magnetization direction of the spin injection layer 22 is the opposite from the direction of the magnetic field generated from the main magnetic pole 12, the magnetization of the spin injection layer 22 is very likely to become unstable. Accordingly, when the direction of the magnetic field generated from the main magnetic pole 12 changes, the magnetization of the spin injection layer 22 needs to promptly change its direction or have such magnetic anisotropy that its magnetization does not change with the magnetic field generated from the main magnetic pole 12. However, the magnetic field from the main magnetic pole 12 is normally over 10 kOe, and therefore, it is difficult to restrict fluctuations of the spin injection layer 22 by magnetic anisotropy. Accordingly, it is preferable that the spin injection layer 22 has such magnetic anisotropy that its magnetization can be readily reversed by the magnetic field generated from the main magnetic pole 12.

Even if the spin injection layer 22 is not a hard magnetic material, it is possible to restrict fluctuations by the magnetic field generated from the main magnetic pole 12. However, when the oscillation layer 24 has oscillations, fluctuations are caused due to the influence of the spin of the electrons flowing from the oscillation layer 24. Therefore, the spin injection layer 22 needs to have such magnetic anisotropy as to reduce the influence. A specific example of the hard magnetic material that can be used as the spin injection layer 22 contains at least one element selected from the group consisting of Fe, Co, and Ni. With such a hard magnetic material, it is possible to achieve a spin polarization rate high enough for spin injection.

Since the magnetization direction of the spin injection layer 22 is substantially perpendicular to the film plane (the upper face or the lower face) of the spin injection layer 22, it is desirable that the magnetic anisotropy has uniaxial anisotropic properties perpendicular to the film plane. Examples of the materials that contain at least one element selected from the group consisting of Fe, Co, and Ni, and can have uniaxial anisotropic properties perpendicular to the film plane include a Fe—Pt alloy, a Co—Pt alloy, a Tb—Fe—Co alloy, a Tb—Co alloy, a Co—Cr—Pt alloy, a Co/Pt stack structure, a Co/Ni stack structure, and a Co—Pd stack structure.

However, when an element that provides magnetic anisotropy such as Pt, Cr, Tb, or Pd is added to an alloy of an element selected from the group consisting of Fe, Co, and Ni, a loss is caused in terms of the spin polarization rate. To compensate for this, the spin injection layer 22 may have a stack structure that is formed with the hard magnetic material, an element selected from the group consisting of Fe, Co, and Ni, and an alloy soft-magnetic layer containing a light element such as Al, Cu, Ga, Ge, or Si. The soft magnetic layer is formed at the interface with the nonmagnetic intermediate layer 23, so that the spin injection layer 22 can achieve the desired magnetic anisotropy and the desired spin polarization rate.

To achieve an excellent spin polarization rate and to obtain an excellent spin injecting function, the spin injection layer 22 needs to have high film quality. Therefore, it is preferable that the spin injection layer 22 has a film thickness of 2 nm or greater. More preferably, the spin injection layer 22 should have a film thickness of 5 nm or greater, so as to absorb fluctuations caused by the spins of electrons flowing from the oscillation layer 24.

The nonmagnetic intermediate layer 23 serves to break the magnetic coupling between the spin injection layer 22 and the oscillation layer 24, and efficiently transmit spin information. Specific examples of the materials that can be used include nonmagnetic metals such as Cu, Au, Ag, Pd, Pt, Al, Ir, and Os, and oxides such as Mg—O, Ti—O, and Hf—O. Since the spin torque oscillator 20 can strengthen the high-frequency magnetic field by increasing the current to be applied, it is preferable to use a metal layer through which a large amount of current can easily flow. The film thickness of the nonmagnetic intermediate layer 23 should preferably be 2 nm or greater, so as to break the magnetic coupling. To transmit the spin information, the film thickness of the nonmagnetic intermediate layer 23 needs to be 100 nm or less, more preferably, 20 nm or less. For these reasons, it is preferable that the film thickness of the nonmagnetic intermediate layer 23 is in the range of 2 nm to 20 nm.

The oscillation layer 24 rotates at high frequency, so as to generate a magnetic field. Therefore, it is preferable that the oscillation layer 24 is formed with a ferromagnetic material having a large product of magnetization and film thickness (Ms·T), so as to obtain a strong magnetic field. An alloy of an element selected from the group consisting of Fe, Co, and Ni is used so as to make the magnetization larger. Meanwhile, to efficiently cause spin torque oscillation, the value of the product Ms·T in the oscillation layer 24 should preferably be small. Therefore, the value of the product Ms·T in the oscillation layer 24 is adjusted, with the high-frequency magnetic field intensity and the oscillation efficiency being taken into account. A magnetization-adjusted layer is formed by adding a light element such as Al, Cu, Ga, Ge, or Si to the alloy of an element selected from the group consisting of Fe, Co, and Ni. To efficiently generate a magnetic field, the oscillation layer 24 needs to have magnetization rotating in a uniform manner. More specifically, if the film thickness of the oscillation layer 24 is 30 nm or less, the magnetization does not rotate in a uniform manner, and the magnetization becomes smaller as a spin wave is generated. Therefore, the film thickness of the oscillation layer 24 needs to be 30 nm or less.

The lower electrode 25 forms a pair with the main magnetic pole 12, and is used to energize the spin torque oscillator 20 in a direction perpendicular to the film plane. To place the oscillation layer 24 closer to the medium 100, the lower electrode 25 should be made as thin as possible. If the thickness of the lower electrode 25 is in the neighborhood of 50 nm, the high-frequency magnetic field generated from the oscillation layer 24 hardly reaches the medium 100. Therefore, the thickness of the lower electrode 25 should preferably be 40 nm or less. To energize the spin torque oscillator 20 in a uniform manner, it is preferable that the lower electrode 25 is thick. If the thickness of the lower electrode 25 is 5 nm or less, the current flowing into the spin torque oscillator 20 becomes extremely uneven.

The return yoke 14 is connected to the upper portion of the main magnetic pole 12, when seen from the air bearing surface 14a of the return yoke 14. The return yoke 14 is designed to disperse the magnetic field of the main magnetic pole 12 in the back of the main magnetic pole 12, so that a magnetic field can be efficiently induced in the main magnetic pole 12. When formed in the vicinity of the medium moving direction side of the air bearing surface 12a of the main magnetic pole 12 (the right-hand side (hereinafter referred to as the trailing end 12b) of the air bearing surface 12a of the main magnetic pole 12 in FIG. 1), the return yoke 14 magnetically interacts with the main magnetic pole 12 near the medium, and serves to gather a strong magnetic field at the trailing end 12b of the main magnetic pole 12. Accordingly, the portion that actually performs recording on the air bearing surface 12a of the main magnetic pole 12 is only the trailing end 12b. Thus, the recording resolution can be made much higher. The field gathering effect becomes larger as the distance between the return yoke 14 and the main magnetic pole 12 becomes shorter. However, if the distance between the return yoke 14 and the main magnetic pole 12 is too short, the magnetic field intensity is absorbed and reduced by the return yoke 14. Therefore, the distance between the return yoke 14 and the main magnetic pole 12 should be 10 nm or longer.

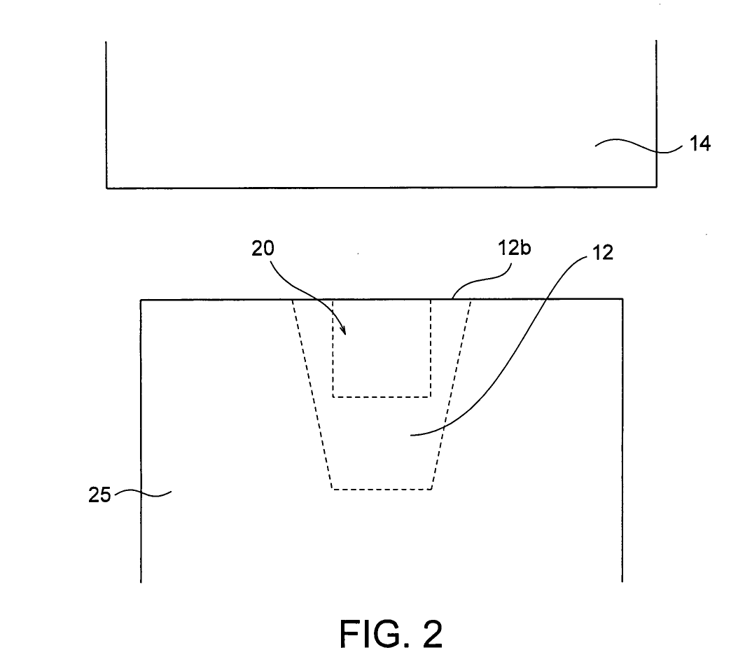

FIG. 2 is a plan view of the magnetic recording head 1 of the first embodiment, seen from the air bearing surface. The spin torque oscillator 20 and the main magnetic pole 12 are located farther away from the medium 100 than the electrode 25 is. To overlap the high-frequency magnetic field with the magnetic field generated from the main magnetic pole 12, the spin torque oscillator 20 is designed to overlap with the air bearing surface 12a of the main magnetic pole 12. The spin injection layer 22 of the spin torque oscillator 20 should preferably have magnetization that can be readily reversed with the magnetic field of the main magnetic field 12. Therefore, it is preferable that the spin torque oscillator 20 is formed within the plane of the air bearing surface 12a of the main magnetic pole 12.

The air bearing surface 12a of the main magnetic pole 12 normally has a trapezoidal shape, as shown in FIG. 2. This is to avoid an increase in linear recording width when the angle between the head and the linear recording direction is large, since the angle between the head and the linear recording direction varies with locations if writing is performed on a circular recording medium with the use of a suspension arm moving between the inner circumference side and the outer circumference side. In other words, the portion that protrudes in the recording width direction when tilted is eliminated in advance, so as to avoid an increase in linear recording width. With such a function being taken into consideration, the recording width is determined in accordance with the length of the longer side of the trapezoid in the magnetic recording head 1.

In the magnetic recording head 1 of this embodiment, the size of the spin torque oscillator 20 (the size of the surface parallel to the medium 100) is smaller than the air bearing surface 12a of the main magnetic pole 12. Accordingly, the magnetic recording width is further defined by the size of the spin torque oscillator 20.

Since the magnetic field of the main magnetic pole 12 is strongest at the trailing end 12b of the main magnetic pole 12, the peak of the high-frequency assistance effect needs to be overlapped with the trailing end 12b in FIG. 2. As the high-frequency magnetic field is generated through rotation of the magnetization of the oscillation layer 24, the direction of the magnetic field also rotates. The high-frequency assistance effect is achieved by enhancing the precessional movement of the magnetization of the recording bits in the medium 100. Therefore, the high-frequency magnetic field should have not only the strength of the high-frequency magnetic field but also the components that match the precessional movement direction of the magnetization of the recording bits in the field rotating direction.

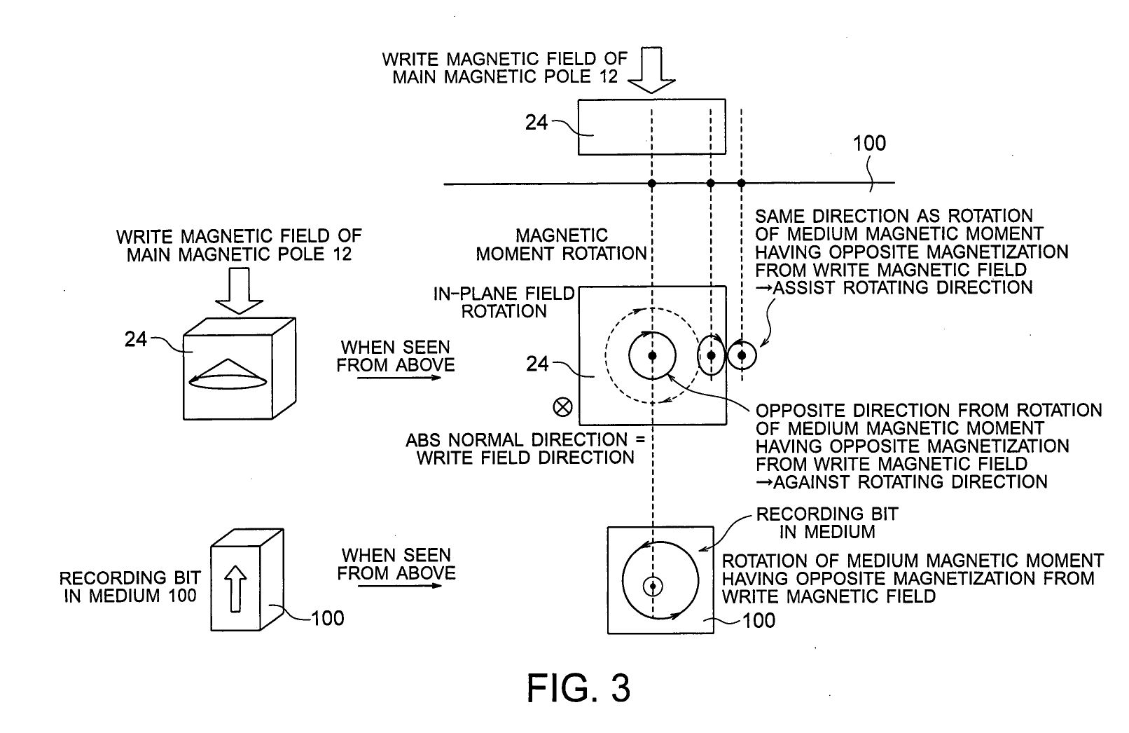

FIG. 3 is a diagram for explaining the movements of the magnetization and a magnetic field observed when the magnetization of a recording bit is reversed with a high-frequency assist recording head. In FIG. 3, the magnetization rotating direction of the oscillation layer 24 and the field rotating direction are shown. In a case where the oscillation layer 24 is seen from the write field direction, the field rotating direction becomes opposite between the inside and the outside of the medium projection plane of the oscillation layer 24. Meanwhile, the rotating direction of the magnetization of the medium 100 is opposite from the rotating direction of the oscillation layer 24, since the magnetization direction of the medium 100 is opposite from the write magnetic field. With the magnetization and field rotating directions being all taken into consideration, the location at which an assistance effect can be achieved is outside the plane of projection of the oscillation layer 24 onto the medium, and should be as close as possible to the oscillation layer 24, so as to obtain a strong magnetic field. Accordingly, the assistance effect becomes largest in the vicinity of the end portion of the oscillation layer 24.

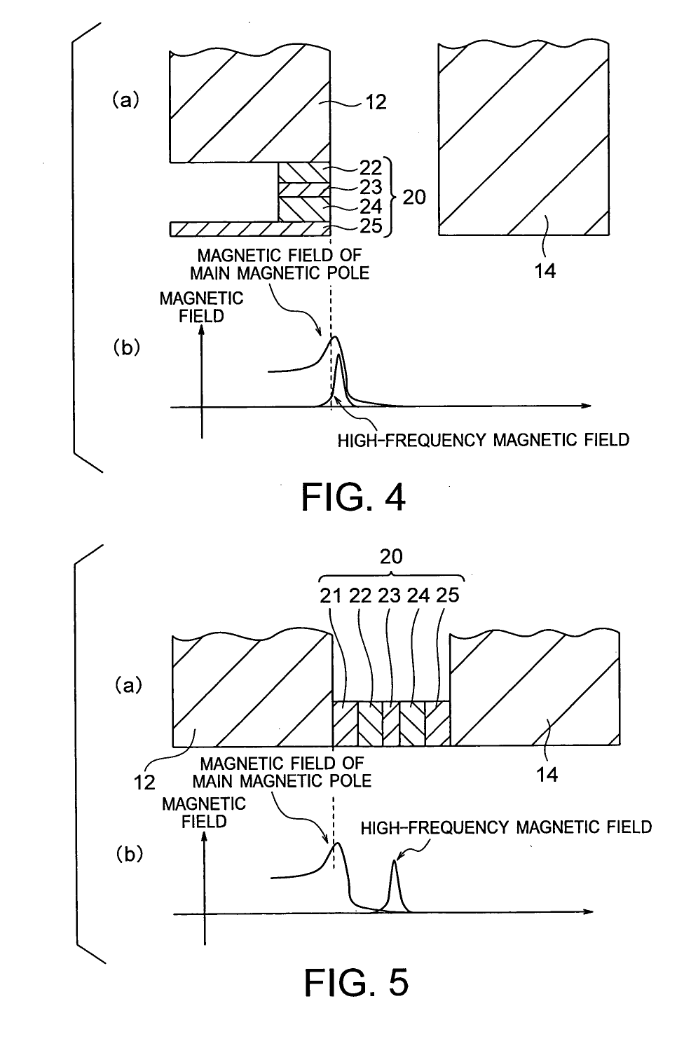

In view of those facts, when the magnetic fields of the main magnetic pole 12 and the spin torque oscillator 20 are overlapped with each other in this embodiment, it is preferable that the end surface of the spin torque oscillator 20 is in line with the trailing end 12b of the main magnetic pole 12, as shown in FIGS. 1 and 2. With this arrangement, the peak positions of the high-frequency assist magnetic field generated from the spin torque oscillator 20 and the recording magnetic field generated from the main magnetic pole 12 can overlap with each other, as shown in FIGS. 4(a) and 4(b). Thus, the recording resolution can be improved, and higher linear recording density can be achieved.

In a magnetic recording head of a comparative example, on the other hand, a spin torque oscillator 20 formed with an electrode 21, a spin injection layer 22, a nonmagnetic intermediate layer 23, an oscillation layer 24, and an electrode 25 is provided in a magnetic gap formed between a main magnetic pole 12 and a return yoke 14. Since there is a great distance between the peak position of the high-frequency assist magnetic field generated from the spin torque oscillator 20 and the peak position of the recording magnetic field generated from the main magnetic pole 12, as shown in FIGS. 5(a) and 5(b), the recording intensity varies in the linear recording direction, and the recording resolution becomes poorer. As a result, the linear recording density cannot be made higher.

### Second Embodiment

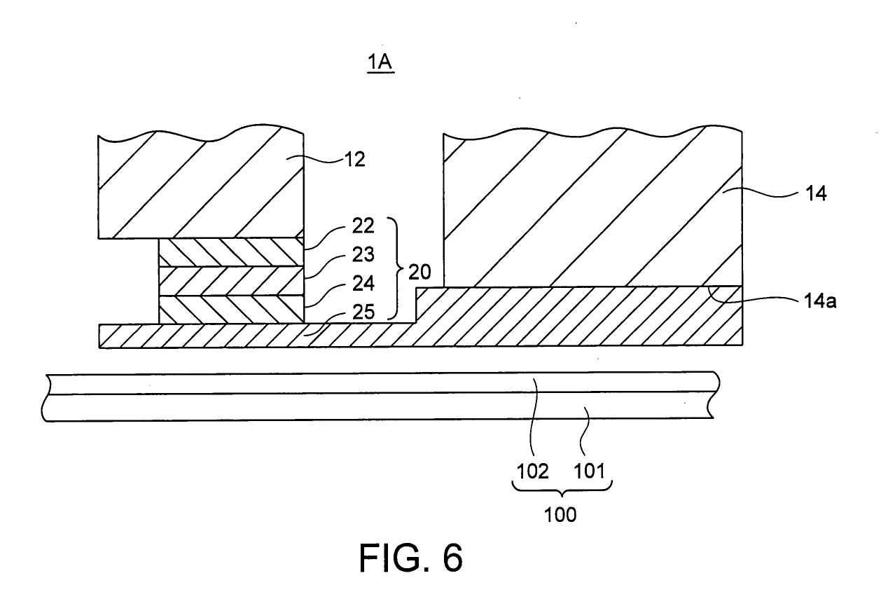

FIG. 6 shows a high-frequency assist magnetic recording head in accordance with a second embodiment of the present invention. FIG. 6 is a cross-sectional view of the magnetic recording head 1A of this embodiment, taken along a plane that is parallel to the medium moving direction or the linear recording direction and perpendicular to the medium surface.

The magnetic recording head 1A of this embodiment is the same as the magnetic recording head 1 of the first embodiment shown in FIG. 1, except that the lower electrode 25 extends to an air bearing surface 14a of the return yoke 14, and is in contact with the air bearing surface 14a. Accordingly, the return yoke 14 also serves as the connecting wire of the lower electrode 25. In this embodiment, the lower electrode 25 has a smaller film thickness on the side of the main magnetic pole 12 than its film thickness on the return yoke side.

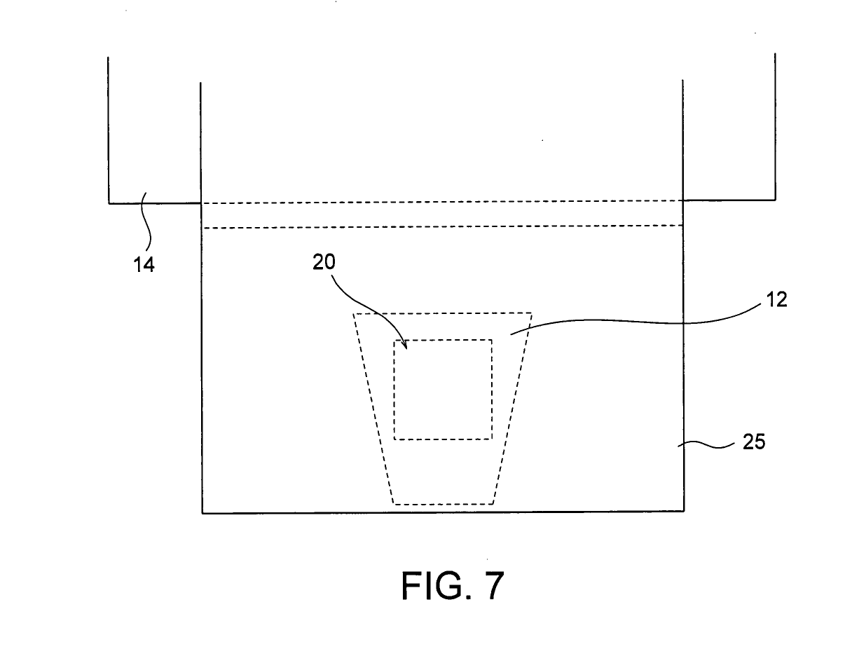

FIG. 7 is a plan view of the magnetic recording head 1A of the second embodiment, seen from the medium 100. The entire lower surface of the magnetic recording head 1A is covered with the lower electrode 25, but the magnetic portion does not differ from that of the first embodiment. Accordingly, as in the first embodiment, the peak positions of the high-frequency assist magnetic field generated from the spin torque oscillator 20 and the recording magnetic field generated from the main magnetic pole 12 can overlap with each other in the magnetic recording head of this embodiment. Thus, the recording resolution can be improved, and higher linear recording density can be achieved.

### Third Embodiment

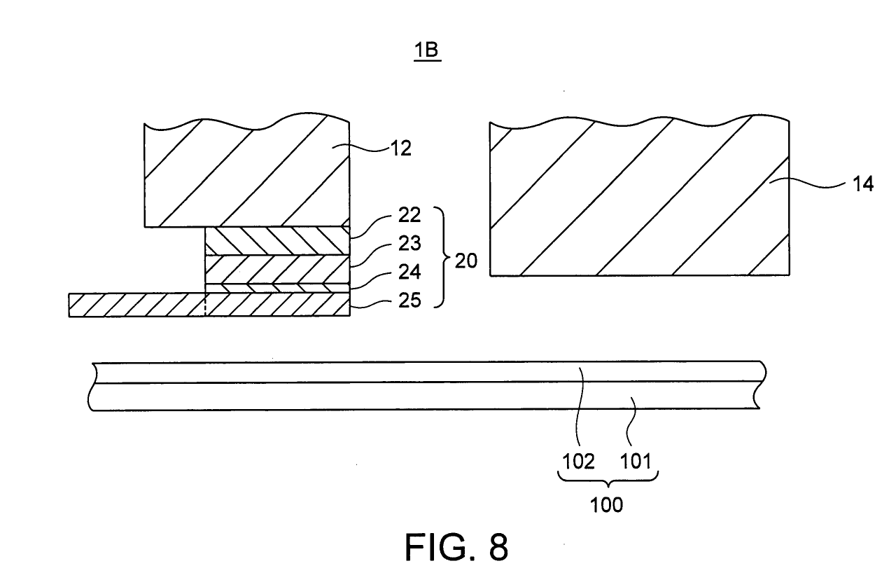

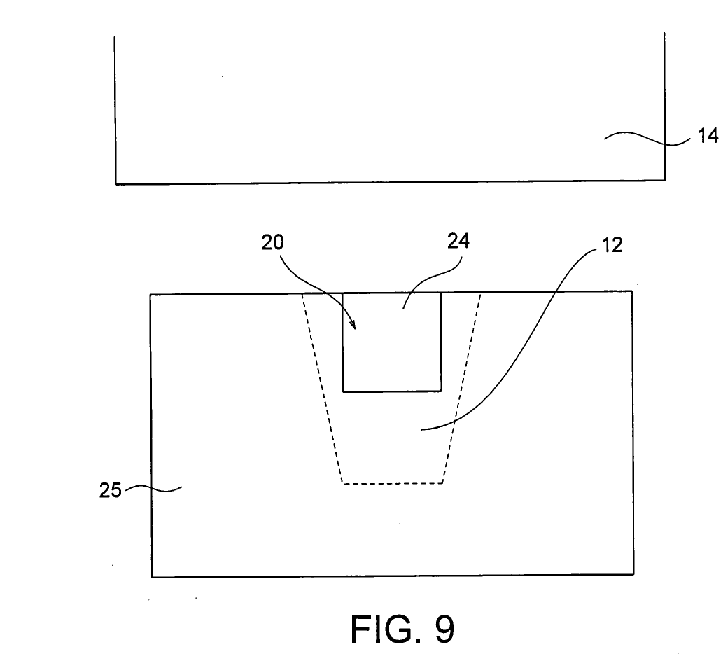

FIG. 8 shows a high-frequency assist magnetic recording head in accordance with a third embodiment of the present invention. FIG. 8 is a cross-sectional view of the magnetic recording head 1B of this embodiment, taken along a plane that is parallel to the medium moving direction or the linear recording direction and perpendicular to the medium surface. FIG. 9 is a plan view of the magnetic recording head 1B of this embodiment, seen from the medium 100.

The magnetic recording head 1B of this embodiment is the same as the magnetic recording head 1 of the first embodiment shown in FIG. 1, except that the lower electrode 25 of the spin torque oscillator 20 surrounds the other side face of the oscillation layer 24 than the side face of the oscillation layer 24 on the side of the return yoke 14. Accordingly, the surface of the spin torque oscillator 20 facing the medium 100, or the surface of the oscillation layer 24 is exposed. In this structure, there are more components having current flowing not perpendicularly to the film plane, and therefore, there is a greater disadvantage in terms of the oscillation efficiency. However, the oscillation layer 24 can be brought closer to the medium 100, so as to obtain a greater high-frequency magnetic field.

As in the first embodiment, the peak positions of the high-frequency assist magnetic field generated from the spin torque oscillator 20 and the recording magnetic field generated from the main magnetic pole 12 can overlap with each other in this embodiment. Thus, the recording resolution can be improved, and higher linear recording density can be achieved.

### Fourth Embodiment

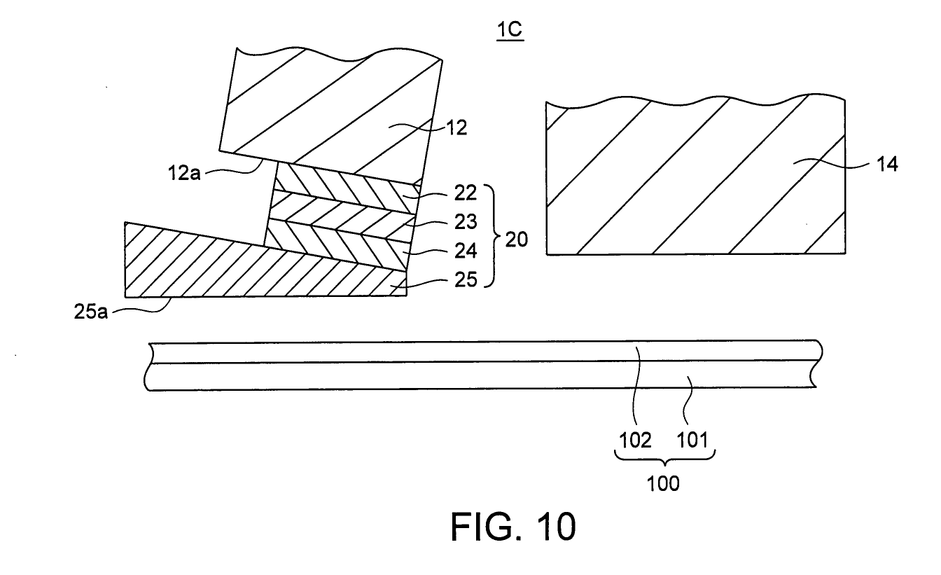

FIG. 10 shows a high-frequency assist magnetic recording head in accordance with a fourth embodiment of the present invention. FIG. 10 is a cross-sectional view of the magnetic recording head 1C of this embodiment, taken along a plane that is parallel to the medium moving direction or the linear recording direction and perpendicular to the medium surface.

The magnetic recording head 1C of this embodiment is the same as the magnetic recording head 1 of the first embodiment shown in FIG. 1, except that the spin torque oscillator 20 is tilted with respect to the medium 100.

In the first embodiment, the upper surface of each layer of the spin torque oscillator 20 is substantially parallel to the upper surface of the medium 100. In this embodiment, on the other hand, the upper surface of each layer of the spin torque oscillator 20 is tilted with respect to the upper surface of the medium 100. Therefore, the air bearing surface 12a of the main magnetic pole 12 is also tilted with respect to the upper surface of the medium 100. The air bearing surface 12a is designed so that the distance between the air bearing surface 12a and the medium 100 becomes longer as the distance from the return yoke 14 becomes longer. The lower electrode 25 is designed so that the surface 25a of the lower electrode 25 facing the medium 100 becomes substantially parallel to the upper surface of the medium 100.

In this embodiment, the oscillation layer 24 can be placed closer to the medium 100, and the angle between the film plane of the oscillation layer 24 and the upper surface of the medium 100 approximates zero, so that the high-frequency magnetic field can be made stronger. Accordingly, the direction of the high-frequency magnetic field generated from the oscillation layer 24 approximates the direction of circularly-polarized light at the center of the medium thickness. Thus, the precessional movement of the medium can be efficiently induced, and the assistance efficiency can be made higher.

As in the first embodiment, the peak position of the high-frequency assist magnetic field generated from the spin torque oscillator 20 can overlap with the peak position of the recording magnetic field generated from the main magnetic pole 12 in the fourth embodiment. Accordingly, the recording resolution can be improved, and higher linear recording density can be achieved.

The first through fourth embodiments include aspects that can be shared among them. For example, in the third embodiment and the fourth embodiment, the lower electrode 25 may be connected to the return yoke 14 as in the second embodiment. Also, the spin injection layers 22, the nonmagnetic intermediate layers 23, and the oscillation layers 24 of the respective embodiments may be made of the same specific materials.

### Fifth Embodiment

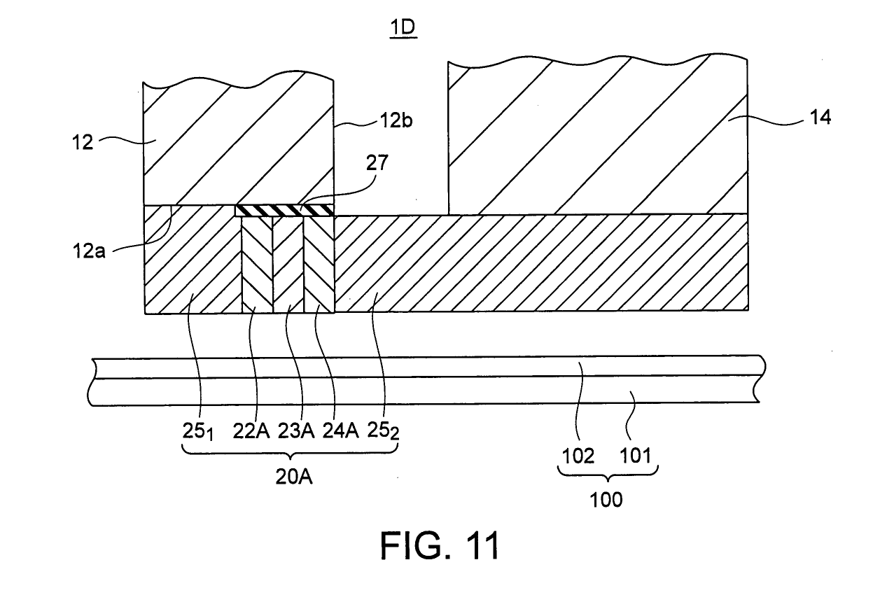

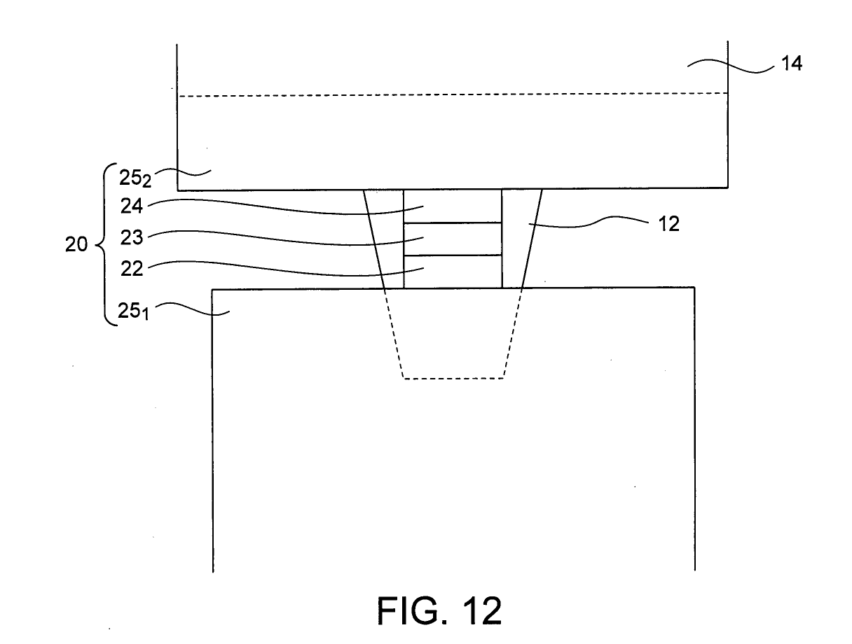

FIG. 11 shows a high-frequency assist magnetic recording head in accordance with a fifth embodiment of the present invention. FIG. 11 is a cross-sectional view of the magnetic recording head 1D of this embodiment, taken along a plane that is parallel to the medium moving direction or the linear recording direction and perpendicular to the medium surface. FIG. 12 is a plan view of the magnetic recording head 1D of this embodiment, seen from the medium 100.

In the magnetic recording head 1D of this embodiment, the upper surfaces of the spin injection layer 22A, the nonmagnetic intermediate layer 23A, and the oscillation layer 24A of a spin torque oscillator 20A are substantially perpendicular to the air bearing surface 12a of the main magnetic pole 12 and the upper surface of the medium 100. Accordingly, part of the side face of each of the spin injection layer 22A, the nonmagnetic intermediate layer 23A, and the oscillation layer 24A of the spin torque oscillator 20A is connected to the main magnetic pole 12 via the air bearing surface 12a of the main magnetic pole 12 and an insulating layer 27. In this manner, the spin injection layer 22A, the nonmagnetic intermediate layer 23A, and the oscillation layer 24A are electrically insulated by the main magnetic pole 12 and the insulating layer 27. An electrode 25₁ is connected to the face of the spin injection layer 22A on the opposite side from the nonmagnetic intermediate layer 23A. This electrode 25₁ is connected to the air bearing surface 12a of the main magnetic pole 12. An electrode 25₂ is connected to the face of the oscillation layer 24A on the opposite side from the nonmagnetic intermediate layer 23A. This electrode 25₂ is connected to the air bearing surface 14a of the return yoke 14. Unlike the spin injection layer 22 and the oscillation layer 24 of the spin torque oscillator 20 of any of the first through fourth embodiments, the spin injection layer 22A and the oscillation layer 24A of the spin torque oscillator 20A of this embodiment have magnetization directions parallel to the film plane.

In this embodiment, the contact faces of the oscillation layer 24 and the electrode 25₂ should preferably be in line with the trailing end 12b of the main magnetic pole 12. With this arrangement, the high-frequency assist magnetic field generated from the spin torque oscillator 20A and the recording magnetic field generated from the main magnetic pole 12 can have peak positions overlapping with each other.

In the magnetic recording head 1D of this embodiment, current flows between the electrode 25₁ and the electrode 25₂, so that the spin torque oscillator 20A generates a high-frequency magnetic field. As in the first embodiment, the spin injection layer 22A changes its direction with a write magnetic field, but has a magnetization direction parallel to the film plane. Therefore, the spin injection layer 22A can be made of a hard magnetic material having magnetic anisotropy parallel to the film plane. More specifically, anisotropy can be readily achieved by adding a rare earth metal or noble metal to an element selected from the group consisting of Fe, Co, and Ni, or an alloy of the element.

Meanwhile, the materials that can be used for the nonmagnetic intermediate layer 23A and the oscillation layer 24A are the same as those of the first embodiment. Like the magnetization direction of the spin injection layer 22A, the magnetization direction of the oscillation layer 24A is parallel to the film plane. The magnetization rotation in this embodiment is not circular as in the first embodiment, but is linear oscillation contained in a two-dimensional space. In the fifth embodiment, the direction of rotation of the high-frequency magnetic field generated from the oscillation layer 24A is such a direction of rotation that can achieve an assistance effect near the trailing end 12b of the main magnetic pole 12, as in the first embodiment. However, the rotational component is smaller than that in the first embodiment, and linear oscillation is caused, instead of rotational oscillation. For the above reasons, the assistance effect is achieved, but the effect is smaller than that in the first embodiment.

As in the first embodiment, the peak position of the high-frequency assist magnetic field generated from the spin torque oscillator 20A can overlap with the peak position of the recording magnetic field generated from the main magnetic pole 12 in the fifth embodiment. Accordingly, the recording resolution can be improved, and higher linear recording density can be achieved.

### Sixth Embodiment

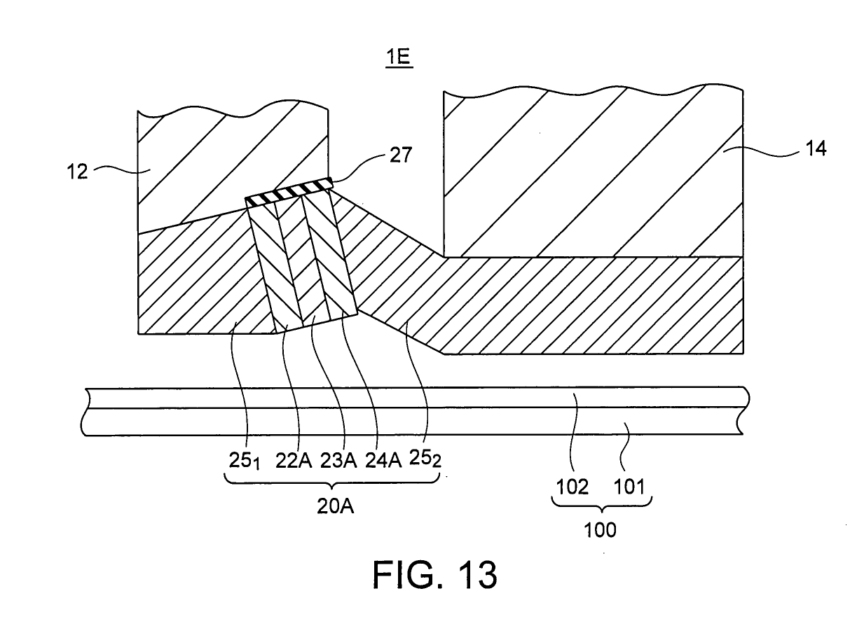

FIG. 13 shows a high-frequency assist magnetic recording head in accordance with a sixth embodiment of the present invention. FIG. 13 is a cross-sectional view of the magnetic recording head 1E of this embodiment, taken along a plane that is parallel to the medium moving direction or the linear recording direction and perpendicular to the medium surface.

The magnetic recording head 1E of this embodiment is the same as the magnetic recording head 1E of the fifth embodiment shown in FIG. 11, except that the spin torque oscillator 20A is tilted with respect to the upper surface of the medium 100. In the fifth embodiment, the upper surface of each of the layers of the spin torque oscillator 20A is substantially perpendicular to the upper surface of the medium 100. In the sixth embodiment, the upper surface of each of the layers of the spin torque oscillator 20A is tilted with respect to a direction perpendicular to the upper surface of the medium 100. As in the fifth embodiment, the upper surface of each of the layers of the spin torque oscillator 20A is substantially perpendicular to the air bearing surface 12a of the main magnetic pole 12 in the sixth embodiment.

In this manner, the spin torque oscillator 20A is tilted with respect to the upper surface of the medium 100, so as to increase the high-frequency magnetic field components in the plane parallel to the upper surface of the medium 100. Thus, the assistance effect is increased.

As in the first embodiment, the peak position of the high-frequency assist magnetic field generated from the spin torque oscillator 20A can overlap with the peak position of the recording magnetic field generated from the main magnetic pole in the sixth embodiment. Accordingly, the recording resolution can be improved, and higher linear recording density can be achieved.

### Seventh Embodiment

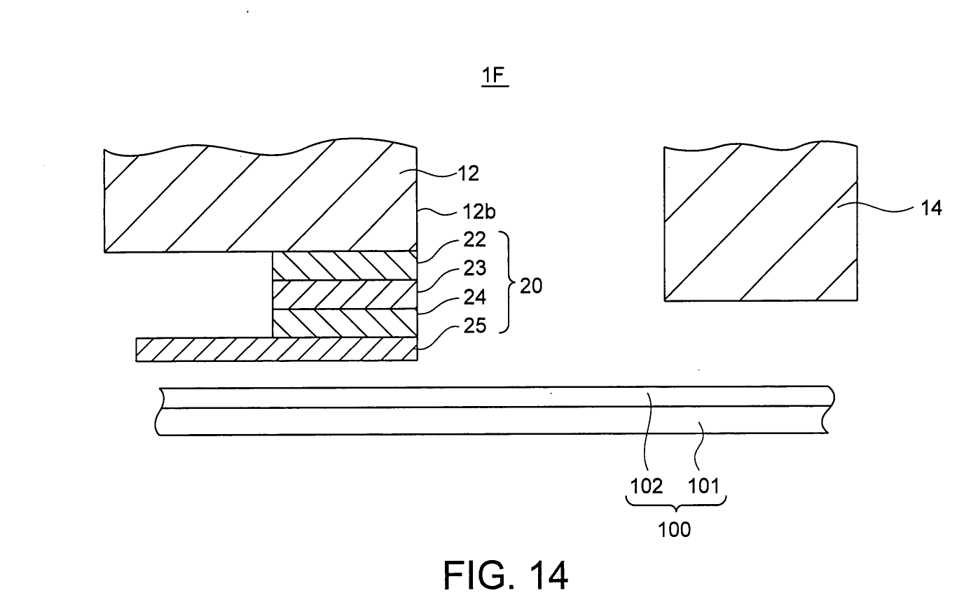

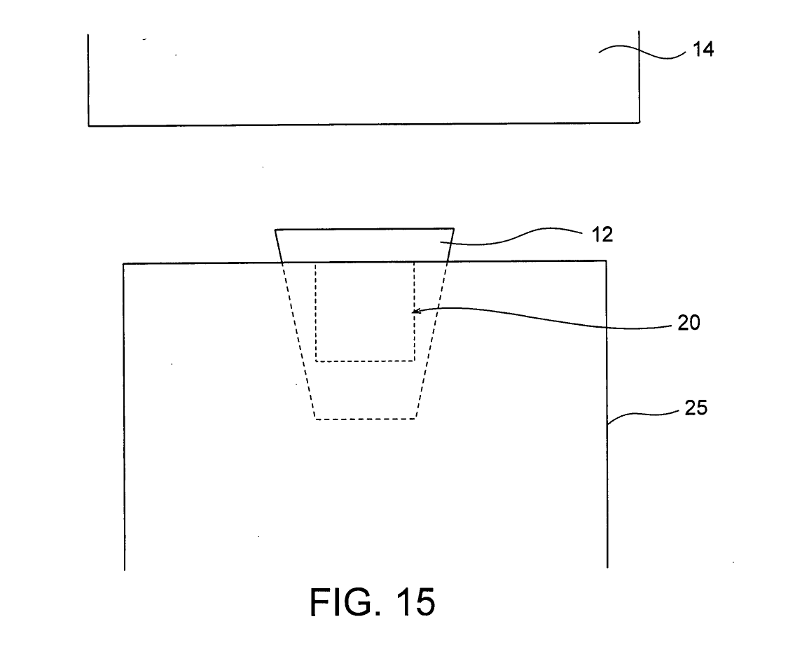

FIG. 14 shows a high-frequency assist magnetic recording head in accordance with a sixth embodiment of the present invention. FIG. 14 is a cross-sectional view of the magnetic recording head 1F of this embodiment, taken along a plane that is parallel to the medium moving direction or the linear recording direction and perpendicular to the medium surface. FIG. 15 is a plan view of the magnetic recording head 1F of this embodiment, seen from the medium 100.

The magnetic recording head 1F of this embodiment is the same as the magnetic recording head 1 of the first embodiment shown in FIG. 1, except that the spin torque oscillator 20 is placed in such an offsetting manner that the distance from the return yoke 14 is longer than the distance to the trailing end 12b of the main magnetic pole 12.

In this embodiment, there is a gap between the peak position of the write magnetic field of the main magnetic pole 12 and the peak position of the high-frequency assist magnetic field of the oscillation layer 24, which is not seen in the first embodiment. However, the write magnetic field induced over the entire spin torque oscillator 20 has higher uniformity, and the spin torque oscillator 20 is stabilized accordingly. In this situation, offsetting is performed in such a manner that the portion overlapping with the write magnetic field is not much reduced. In this manner, the size of the high-frequency magnetic field of the trailing end 12b can be increased. The optimum offset range to achieve magnetic field uniformity is 5 nm to 10 nm from the trailing end 12b. If the offset range exceeds 10 nm, the overlapping portion vanishes, which is not preferable. In this embodiment, it is essential in terms of field uniformity that the spin torque oscillator 20 remains within the medium projection plane of the main magnetic pole 12 even when shifted.

In the magnetic recording head 1F of this embodiment, the lower electrode 25 of the spin torque oscillator 20 may be connected to the return yoke 14, so that current flows into the spin torque oscillator 20 through the return yoke 14, as in the magnetic recording head 1A of the second embodiment shown in FIG. 6.

Alternatively, the lower electrode 25 may be designed to surround the oscillation layer 24, as in the magnetic recording head 1B of the third embodiment shown in FIG. 8.

As in the first embodiment, the peak position of the high-frequency assist magnetic field generated from the spin torque oscillator 20 can overlap with the peak position of the recording magnetic field generated from the main magnetic pole 12 in the seventh embodiment. Accordingly, the recording resolution can be improved, and higher linear recording density can be achieved.

### Eighth Embodiment

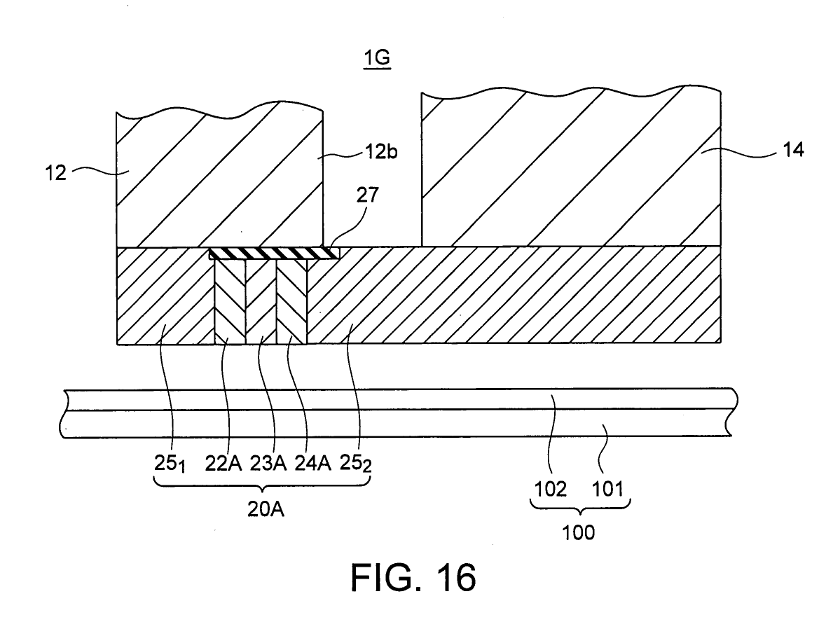

FIG. 16 shows a high-frequency assist magnetic recording head in accordance with an eighth embodiment of the present invention. FIG. 16 is a cross-sectional view of the magnetic recording head 1G of this embodiment, taken along a plane that is parallel to the medium moving direction or the linear recording direction and perpendicular to the medium surface.

The magnetic recording head 1G of this embodiment is the same as the magnetic recording head 1D of the fifth embodiment shown in FIG. 11, except that the contact face between the oscillation layer 24A of the spin torque oscillator 20A and the electrode 25₂ is offset so that the distance from the return yoke 14 becomes longer than the distance to the trailing end 12b of the main magnetic pole 12. The effect achieved by the offsetting is the same as in the case of the seventh embodiment, which is increasing the uniformity of the magnetic field induced in the spin torque oscillator 20A and stabilizing the oscillation of the spin torque oscillator 20A. The optimum offset amount is 5 nm to 10 nm.

As in the fifth embodiment, the peak position of the high-frequency assist magnetic field generated from the spin torque oscillator 20A can overlap with the peak position of the recording magnetic field generated from the main magnetic pole in the eighth embodiment. Accordingly, the recording resolution can be improved, and higher linear recording density can be achieved.

### Ninth Embodiment

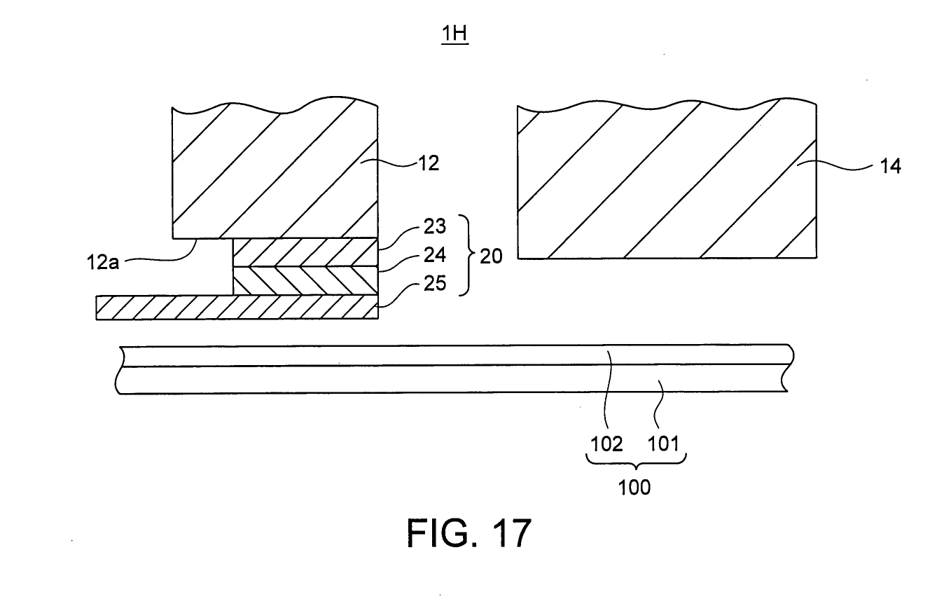

FIG. 17 shows a high-frequency assist magnetic recording head in accordance with a ninth embodiment of the present invention. FIG. 17 is a cross-sectional view of the magnetic recording head 1H of this embodiment, taken along a plane that is parallel to the medium moving direction or the linear recording direction and perpendicular to the medium surface.

The magnetic recording head 1H of this embodiment is the same as the magnetic recording head 1 of the first embodiment shown in FIG. 1, except that the main magnetic pole 12 also serves as the spin injection layer 22 of the spin torque oscillator 20. Since the main magnetic pole 12 is made of a soft magnetic material in this structure, the main magnetic pole 12 is likely to be affected by fluctuations caused when the oscillation layer 24 oscillates. However, the main magnetic pole has a large volume, and is not actually affected by fluctuations. Also, as the main magnetic pole 12 can approach the medium 100 by the amount obtained by eliminating the spin injection layer 22, the write magnetic field can be made stronger. However, the magnetization direction of the main magnetic pole 12 is changed as the distance from the air bearing surface 12a becomes longer. Therefore, components that cancel the spin injecting effect enter the main magnetic pole 12. To prevent this, an oxide or a heavy element such as Pt or Ru is added to the main magnetic pole 12, so as to shorten the spin correlation length.

In the ninth embodiment, the lower electrode 25 of the spin torque oscillator 20 may be connected to the return yoke 14, so that current flows into the spin torque oscillator 20 through the return yoke 14, as in the second embodiment shown in FIG. 6. Alternatively, the lower electrode 25 may be designed to surround the oscillation layer 24, as in the third embodiment shown in FIG. 8.

As in the first embodiment, the peak position of the high-frequency assist magnetic field generated from the spin torque oscillator 20 can overlap with the peak position of the recording magnetic field generated from the main magnetic pole in the ninth embodiment. Accordingly, the recording resolution can be improved, and higher linear recording density can be achieved.

### Tenth Embodiment

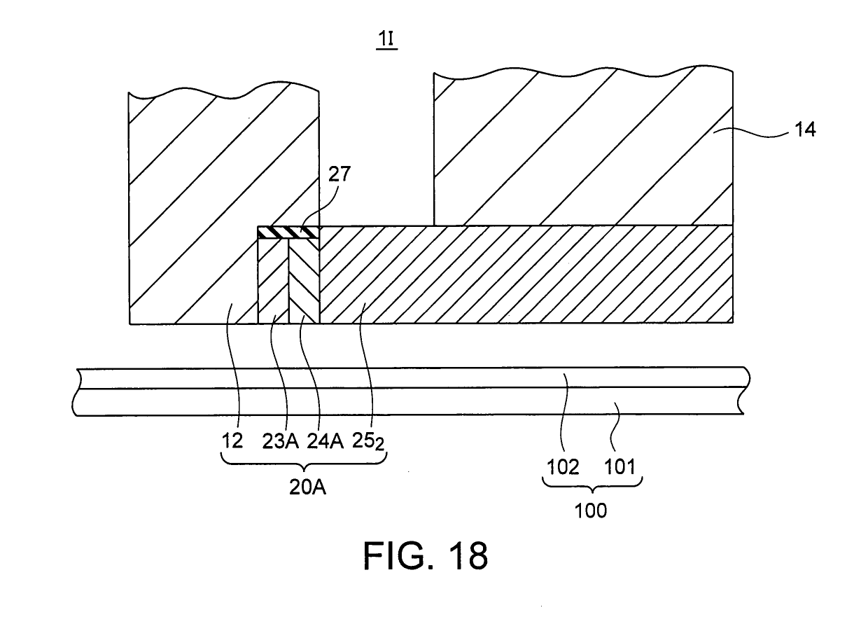

FIG. 18 shows a high-frequency assist magnetic recording head in accordance with a tenth embodiment of the present invention. FIG. 18 is a cross-sectional view of the magnetic recording head 1I of this embodiment, taken along a plane that is parallel to the medium moving direction or the linear recording direction and perpendicular to the medium surface.

The magnetic recording head 1I of this embodiment is the same as the magnetic recording head of the fifth embodiment shown in FIG. 11, except that the electrode 25₁ and the spin injection layer 22A of the spin torque oscillator 20A are eliminated, and the main magnetic pole 12 also serves as the electrode 25₁ and the spin injection layer 22A. As in the ninth embodiment, the main magnetic pole 12 in this structure is also made of a soft magnetic material, and therefore, the main magnetic pole 12 is likely to be affected by fluctuations caused by oscillation of the oscillation layer 24. However, since the main magnetic pole 12 has a large volume, there is no actual influence of the fluctuations.

However, the magnetization direction of the main magnetic pole 12 is changed as the distance from the air bearing surface 12a becomes longer. Therefore, components that cancel the spin injecting effect enter the main magnetic pole 12. To prevent this, an oxide or a heavy element such as Pt or Ru is added to the main magnetic pole 12, so as to shorten the spin correlation length.

As in the fifth embodiment, the peak position of the high-frequency assist magnetic field generated from the spin torque oscillator 20A can overlap with the peak position of the recording magnetic field generated from the main magnetic pole in the tenth embodiment. Accordingly, the recording resolution can be improved, and higher linear recording density can be achieved.

### Eleventh Embodiment

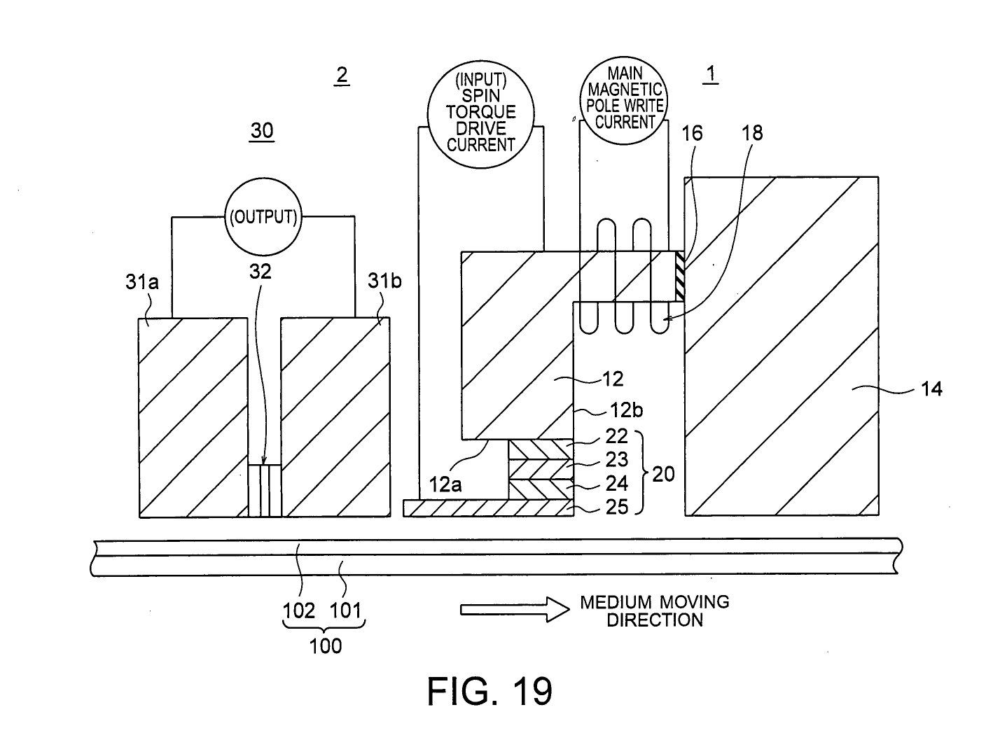

FIG. 19 shows a magnetic head in accordance with an eleventh embodiment of the present invention. FIG. 19 is a cross-sectional view of the magnetic head 2 of this embodiment, taken along a plane that is parallel to the medium moving direction or the linear recording direction and perpendicular to the medium surface.

The magnetic head 2 of this embodiment is a magnetic recording/reproducing head that includes the magnetic recording head 1 of the first embodiment and a reproducing head (a reproducing unit) 30 that reads signals recorded on the medium 100. The reproducing head 30 includes a magnetoresistive device 32 and a pair of shields 31a and 31b that sandwich the magnetoresistive device 32 so as to improve the reading resolution of the magnetoresistive device 32. The magnetoresistive device 32 is formed with a tunnel magnetoresistive film, and the shields 31a and 31b are formed with a soft magnetic material such as Permalloy. The shields 31a and 31b are designed to function as electrodes that energize the magnetoresistive device 32. In the spin torque oscillator 20, the spin injection layer 22 may be formed with a CoPt alloy of 10 nm in film thickness, the nonmagnetic intermediate layer 23 is formed with a Cu film of 5 nm in film thickness, and the oscillation layer 24 is formed with a CoFeAl alloy of 15 nm in film thickness. The lower electrode 25 is formed with a stack structure of a Ta layer, a Cu layer, and a Ta layer, and has a thickness of 10 nm in total. The size of each face of the layers of the spin torque oscillator 20 that are parallel to the medium 100 is 50 nm square, except for the lower electrode 25. The size of the air bearing surface 12a of the main magnetic pole 12 is 100 nm in the recording width direction and is 200 nm in the medium moving direction.

The drive current of the spin torque oscillator 20 is set to flow from the lower electrode 25 toward the main magnetic pole 12 with a low voltage or a low current. The coil 18 is wound around the main magnetic pole 12, so as to induce a write magnetic field. The coil 18 functions to convert information in the write field direction, and adjust the write current. The return yoke 14 is formed at a distance of 40 nm from the trailing end 12b of the main magnetic pole 12.

As a comparative example, a structure that is the same as the magnetic head of this embodiment except that the magnetic recording head 1 is replaced with the magnetic recording head shown in FIG. 5(a) is formed. The reproducing head of the comparative example is the same as the reproducing head 30 of this embodiment, and the spin torque oscillator 20 of the comparative example is also made of the same material and has the same film thickness as the spin torque oscillator 20 of this embodiment. The distance between the trailing end 12b of the main magnetic pole 12 and the return yoke 14 is 40 nm. The size of the main magnetic pole 12 is 80 nm in the recording width direction, and is 160 nm in the medium moving direction. The magnetic recording medium 100 is a perpendicular recording medium.

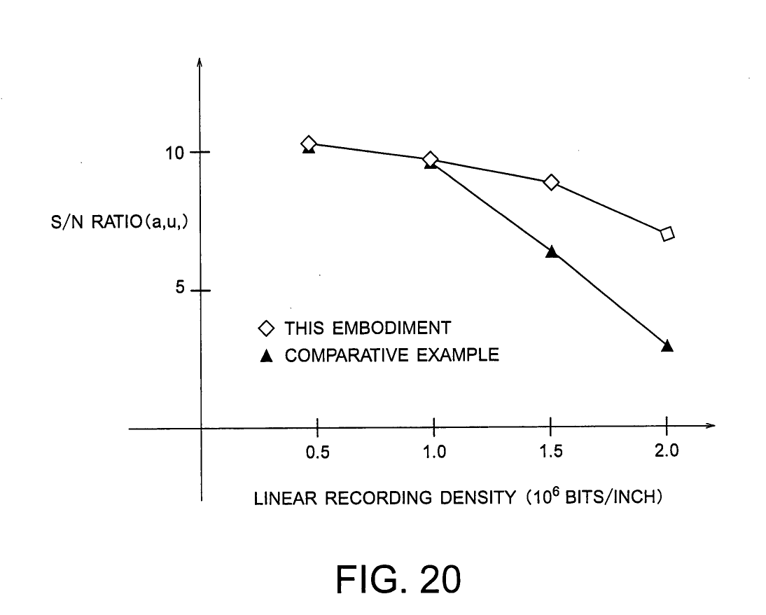

FIG. 20 shows the signal-to-noise ratios (S/N ratios) of the magnetic head of this embodiment and the magnetic head of the comparative example. As can be seen from FIG. 20, there is no difference in signal-to-noise ratio before the linear recording density reaches approximately 10⁶ bits/inch. However, after the linear recording density exceeds 10⁶ bits/inch, the S/N ratio of the comparative example becomes much lower due to the problem of blurring. On the other hand, the decrease in the S/N ratio of the magnetic head of this embodiment is smaller than that of the comparative example, and accordingly, the magnetic head of this embodiment is superior to the magnetic head of the comparative example.

### Twelfth Embodiment

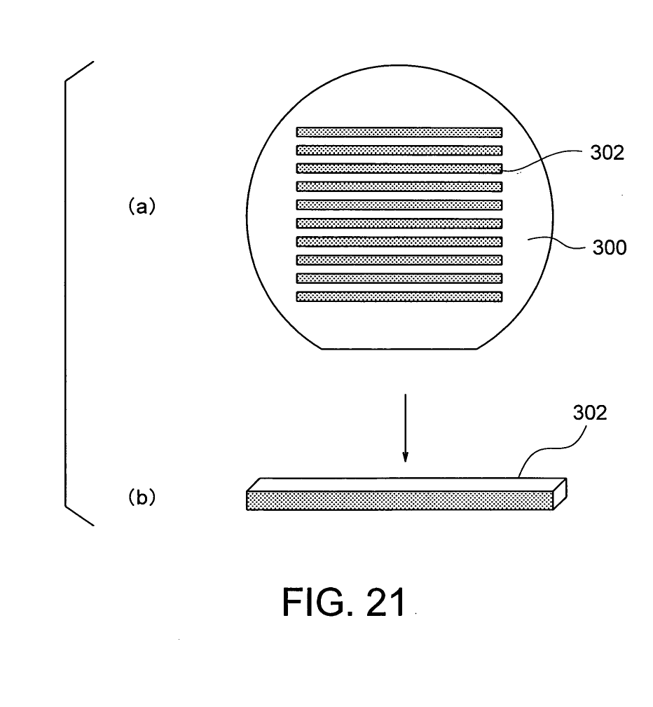

Referring now to FIGS. 21 through 25, a method for manufacturing a magnetic recording head in accordance with a twelfth embodiment of the present invention is described. By the manufacture method in accordance with this embodiment, the magnetic recording head 1A of the second embodiment illustrated in FIG. 6 is manufactured.

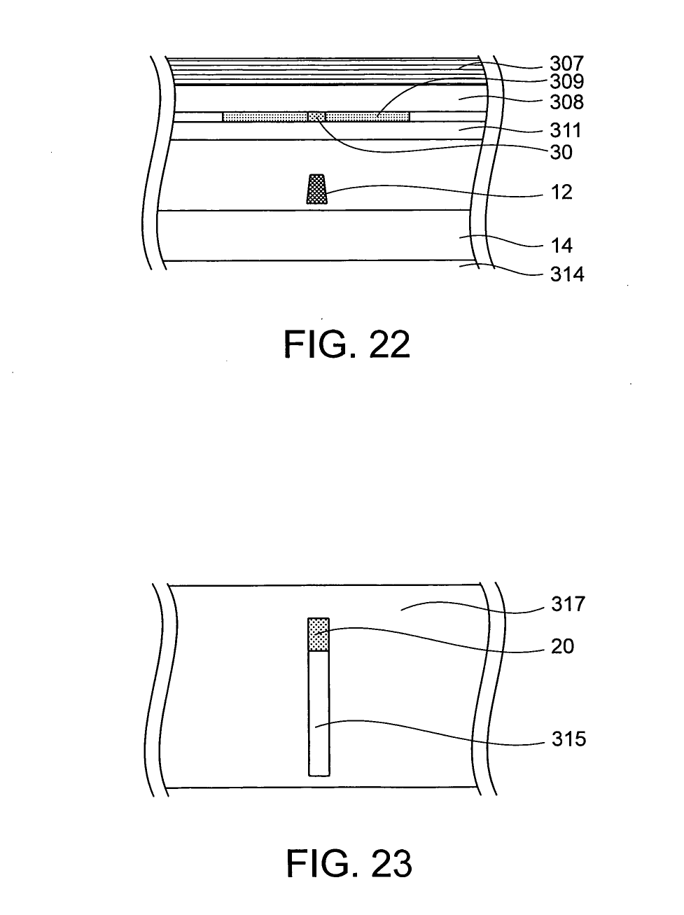

FIG. 21(a) shows bars 302 that are processed into stick-like parts during the process for producing a hard disk drive head. In this process, the reproducing head (the reproducing unit), the main magnetic pole, the return yoke, and the other necessary parts of the magnetic head are formed on a wafer 300. After that, the wafer is cut and divided into so-called sliders that are several hundreds microns in size. FIG. 21(b) shows one of the bars 302 cut out of the wafer 300. FIG. 22 shows the bar 302, seen from the direction indicated by the arrow in FIG. 21(b). Reference numeral 307 indicates an AlTiC substrate. Reference numeral 308 indicates an electrode layer that electrifies the reproducing unit, and also serves as a shield layer for improving the space resolution in the reading power of the reproducing unit. Reference numeral 309 indicates a hard magnetic layer for magnetically stabilizing the reproducing unit. Reference 30 indicates the reproducing unit that may be formed with a tunnel magnetoresistive film or the like. Reference numeral 311 indicates an electrode layer that electrifies the reproducing unit 30, and also serves as a shield layer for improving the space resolution in the reading power of the reproducing unit 30. Reference numeral 12 indicates the main magnetic pole. Reference numeral 14 indicates the return yoke. Reference numeral 314 indicates the portion where wires are provided.

FIG. 23 illustrates a situation where the spin torque oscillator 20 is formed on a wafer and is formed into a stick-like shape through the same procedures as those shown in FIG. 21. Reference numeral 317 indicates the substrate for forming the spin torque oscillator 20. In FIG. 23, the spin torque oscillator 20 is seen from the layer stacking direction. Reference numeral 315 indicates the electrode of the spin torque oscillator 20. The faces shown in FIG. 22 and FIG. 23 are bonded to each other, so as to complete the magnetic recording head shown in FIG. 6

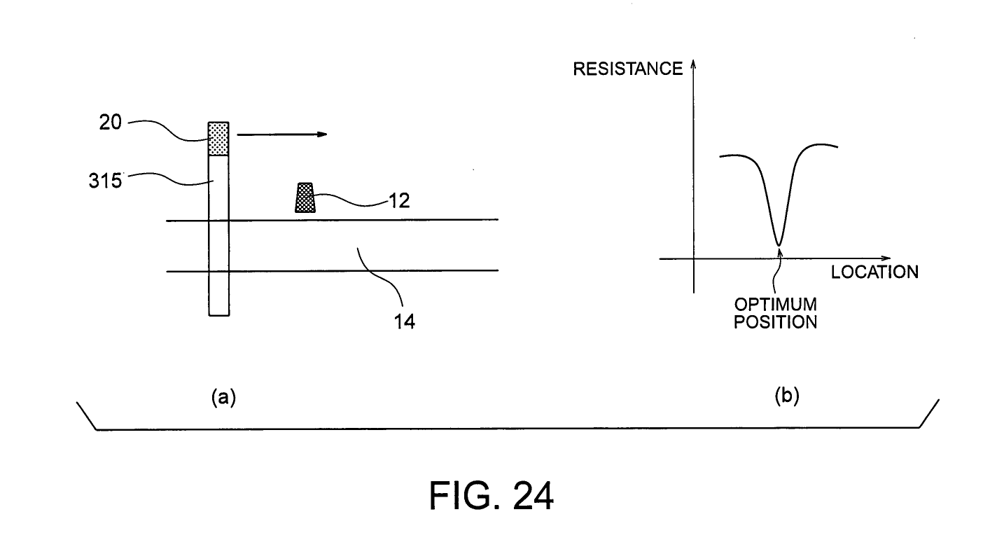

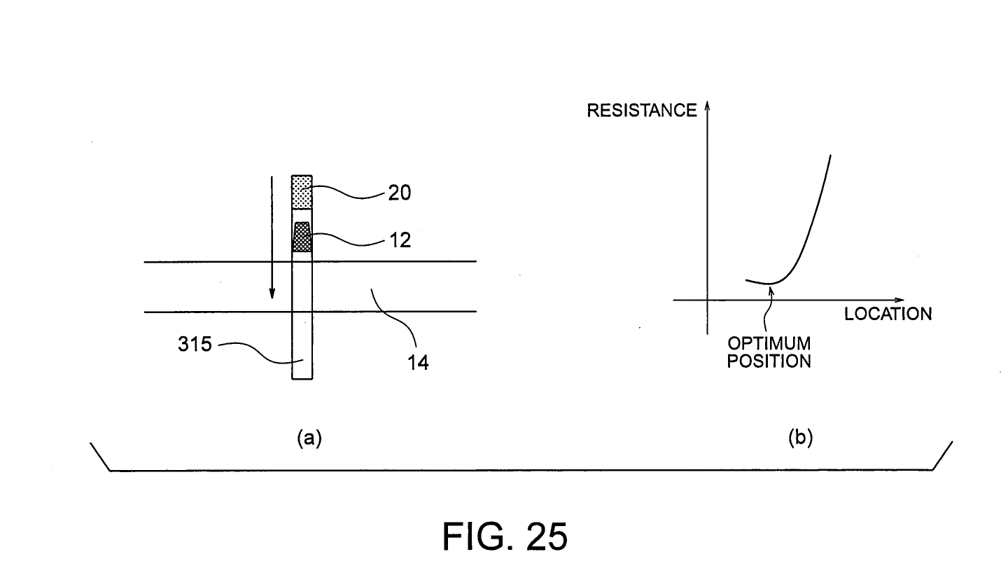

Referring now to FIGS. 24(a) through 25(b), the procedures for overlapping the main magnetic pole 12 and the spin torque oscillator 20 are described. As shown in FIG. 24(a), the electrode 315 is much longer than the distance between the main magnetic pole 12 and the return yoke 14. As described in the second embodiment, the main magnetic pole 12 and the return yoke 14 also serve as an electrode of the spin torque oscillator 20, and have an energizing function. Accordingly, by observing the resistance between the main magnetic pole 12 and the return yoke 14 while the spin torque oscillator 20 is moved in the direction indicated by the arrow in FIG. 24(a), it is possible to determine the optimum position at which the resistance becomes low in the horizontal direction. FIGS. 25(a) and 25(b) illustrate the method for determining the optimum position in the vertical direction after determining the optimum position in the horizontal direction. As in the case of the horizontal direction, the optimum position in the vertical direction can be determined by observing the resistance between the main magnetic pole 12 and the return yoke 14. As the spin torque oscillator 20 is moved in the direction indicated by the arrow in FIG. 25(a), the resistance becomes high when the spin torque oscillator 20 is separated from the main magnetic pole 12. Thus, the position at which the spin torque oscillator 20 overlaps with the main magnetic pole 12 can be determined.

### Thirteenth Embodiment

Next, a magnetic recording apparatus in accordance with a thirteenth embodiment of the present invention is described.

The magnetic head of any of the first through eleventh embodiments can be incorporated into a magnetic head assembly of a recording/reproducing type, and be mounted on a magnetic recording apparatus. The magnetic recording apparatus of this embodiment may have only a recording function, or may have both a recording function and a reproducing function.

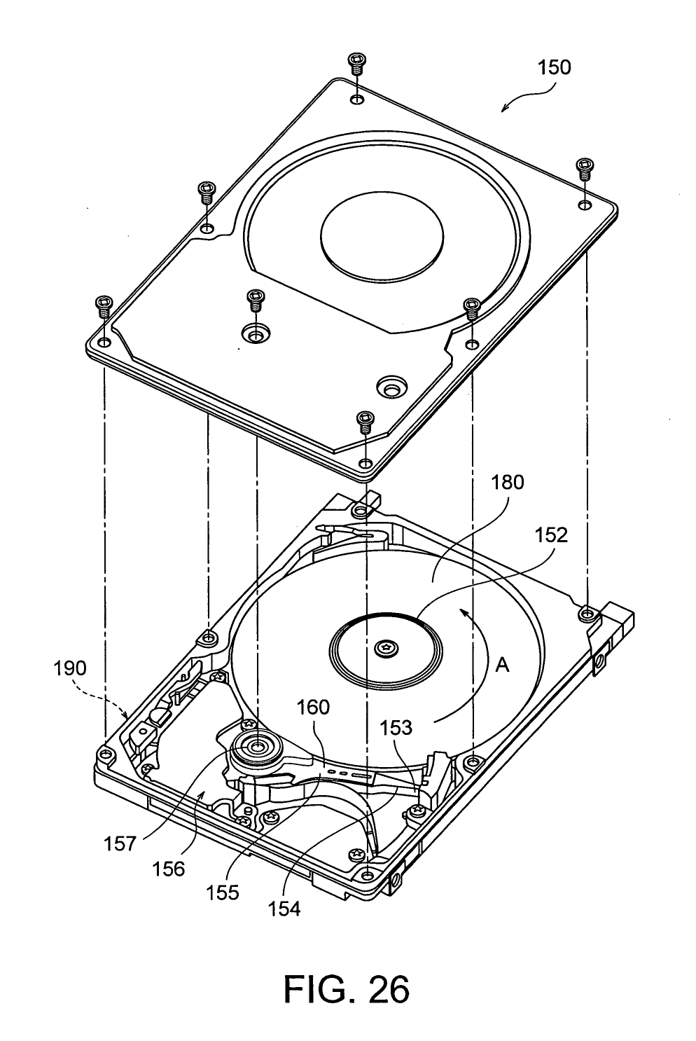

FIG. 26 is a schematic perspective view of an example structure of the magnetic recording apparatus in accordance with the thirteenth embodiment of the present invention. As shown in FIG. 26, the magnetic recording apparatus 150 of this embodiment is an apparatus that includes a rotary actuator. In FIG. 26, a recording medium disk 180 is attached to a spindle motor 152, and is rotated in the direction of the arrow A by a motor (not shown) that responses to a control signal transmitted from a drive control unit (not shown). The magnetic recording apparatus 150 of this embodiment may include two or more recording medium disks 180.

A head slider 153 that performs recording and reproduction of the information stored in the recording medium disk 180 is attached to the top end of a thin-film suspension 154. The head slider 153 has the magnetic head of one of the above embodiments mounted on the top end portion thereof.

When the recording medium disk 180 is rotated, the air bearing surface (ABS) of the head slider 153 is maintained at a predetermined floating distance from the surface of the recording medium disk 180. Alternatively, a “contact-running type” structure in which the head slider 153 is brought into contact with the recording medium disk 180 may be employed.

The suspension 154 is connected to an end of an actuator arm 155 having a bobbin unit or the like that holds the drive coil (not shown). A voice coil motor 156 that is a linear motor is provided at the other end of the actuator arm 155. The voice coil motor 156 may be formed with the drive coil (not shown) that is wound around the bobbin unit of the actuator arm 155, and a magnetic circuit that includes a permanent magnet and an opposed yoke arranged to face each other and sandwich the drive coil.

The actuator arm 155 is held by ball bearings (not shown) provided at upper and lower portions of a bearing unit 157, and rotatably slides by virtue of the voice coil motor 156.

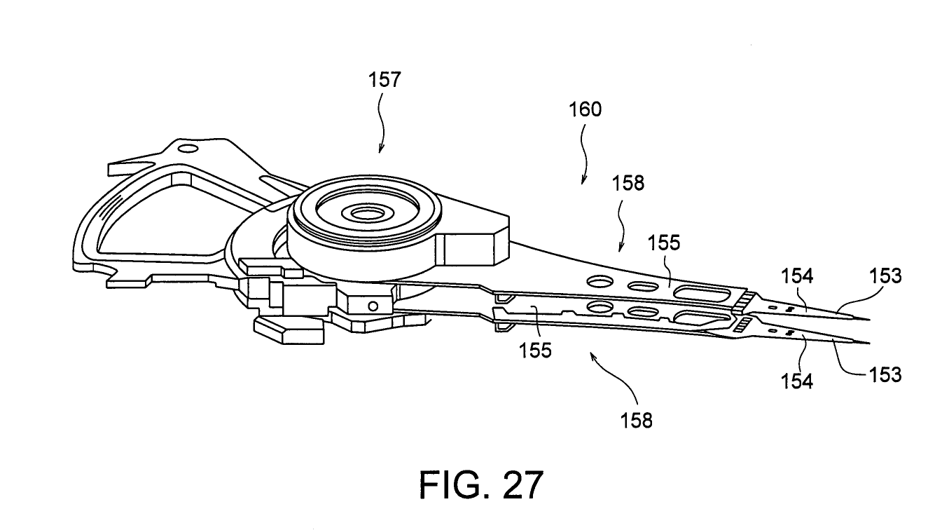

FIG. 27 shows an example structure of a part of a magnetic recording apparatus in accordance with this embodiment. FIG. 27 is an enlarged perspective view of a magnetic head assembly 160 excluding the actuator arm 155, seen from the disk side. As shown in FIG. 14, the magnetic head assembly 160 includes the bearing unit 157, a head gimbal assembly (hereinafter referred to as the HGA) 158 extending from the bearing unit 157, and a supporting frame 146 that extends from the bearing unit 157 in the opposite direction from the extending direction of the HGA 158 and supports the coil 147 of the voice coil motor. The HGA 158 includes the actuator arm 155 extending from the bearing unit 157, and the suspension 154 extending from the actuator arm 155.

The head slider 153 having the magnetic head of one of the first through eleventh embodiments mounted thereto is attached to the top end of the suspension 154.

In short, the magnetic head assembly 160 of this embodiment includes the magnetic head of one of the first through eleventh embodiments, the suspension 154 having the magnetic head mounted to its one end, and the actuator arm 155 connected to the other end of the suspension 154.

The suspension 154 has lead wires (not shown) for signal writing and reading, and the lead wires are electrically connected to the respective electrodes of the magnetic recording head incorporated into the head slider 153. Electrode pads (not shown) are also provided in the magnetic head assembly 160. In this specific example, eight electrode pads are provided. More specifically, there are two electrode pads for the coil of a main magnetic pole, two electrode pads for a magnetic reproducing element, two electrode pads for a DFH (Dynamic Flying Height), and two electrode pads for the spin torque oscillator 10.

A signal processing unit 190 (not shown) that performs signal writing and reading on a magnetic recording medium with the use of a magnetic recording head is also provided. The signal processing unit 190 may be provided on the back face side of the magnetic recording apparatus 150 shown in FIG. 26, for example. The input and output lines of the signal processing unit 190 are connected to the electrode pads, and are electrically connected to the magnetic recording head.

As described above, the magnetic recording apparatus 150 of this embodiment includes: a magnetic recording medium; the magnetic head of one of the first through third embodiments; a moving unit that allows the magnetic recording medium and the magnetic head to move relative to each other, while keeping the magnetic recording medium and the magnetic head at a distance from each other or in contact with each other; a position control unit that places the magnetic head at a predetermined recording position on the magnetic recording medium; and a signal processing unit that performs signal writing and reading on the magnetic recording medium with the use of the magnetic head. The magnetic recording medium is the recording medium disk 180. The moving unit may include the head slider 153. The position control unit may include the magnetic head assembly 160.

As described above, the magnetic recording apparatus of this embodiment includes the magnetic head of one of the first through eleventh embodiments. Accordingly, the reversal time of the spin torque oscillator can be minimized.

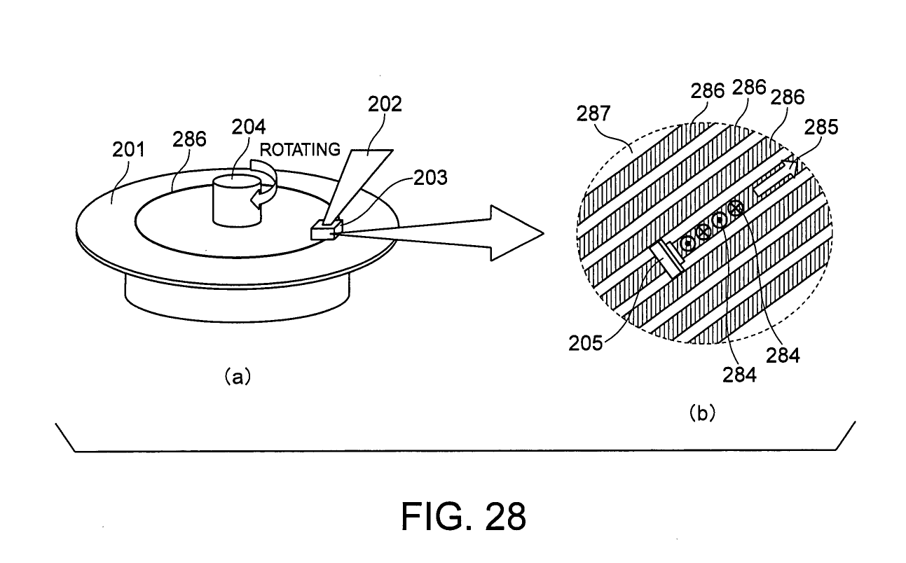

FIGS. 28(a), 28(b) illustrate a first specific example of a magnetic recording medium that can be used with the magnetic head of any of the embodiments of the present invention.

The magnetic recording medium 201 of this specific example has vertically-orientated multi-particle magnetic discrete tracks 286 that are isolated from one another by nonmagnetic material (or air) 287. As the magnetic recording medium 201 is rotated by a spindle motor 204 and is moved in the medium moving direction, recording magnetization 284 is formed by a magnetic head 205 mounted on a head slider 203. The head slider 203 is attached to the top end of a suspension 202. This suspension 202 has lead wires for signal writing and reading, and the lead wires are electrically connected to the respective electrodes of the magnetic head 205 incorporated into the head slider 203.

The width (TS) of the spin torque oscillator in the recording track width direction is made equal to or greater than the recording track width (TW), and equal to or smaller than the recording track pitch (TP), so that the decrease in the coercive force of the adjacent recording tracks due to the leakage high-frequency magnetic field generated from the spin torque oscillator can be greatly reduced. Accordingly, effective high-frequency field assist recording can be performed on the target recording track on the magnetic recording medium 201 of this specific example. Particularly, as a high-frequency magnetic field has high frequency and does not have a shielding effect, it is difficult to reduce blurred recording on adjacent recording tracks with a shield provided in the track width direction. With the use of the magnetic head of any of the embodiments of the present invention, the problem of erasing on adjacent recording tracks can be solved in a magnetic recording/reproducing apparatus that uses the magnetic recording medium 201 shown in FIGS. 28(a), 28(b). Also, in this specific example, the medium magnetic particle size can be further reduced (to a nanometer size) by employing a medium magnetic material with high magnetic anisotropy energy Kᵤ such as FePt or SmCo on which writing cannot be performed with a conventional magnetic head. Thus, it is possible to realize a magnetic recording apparatus having a much higher linear recording density than ever even in the recording track direction (the bit direction).

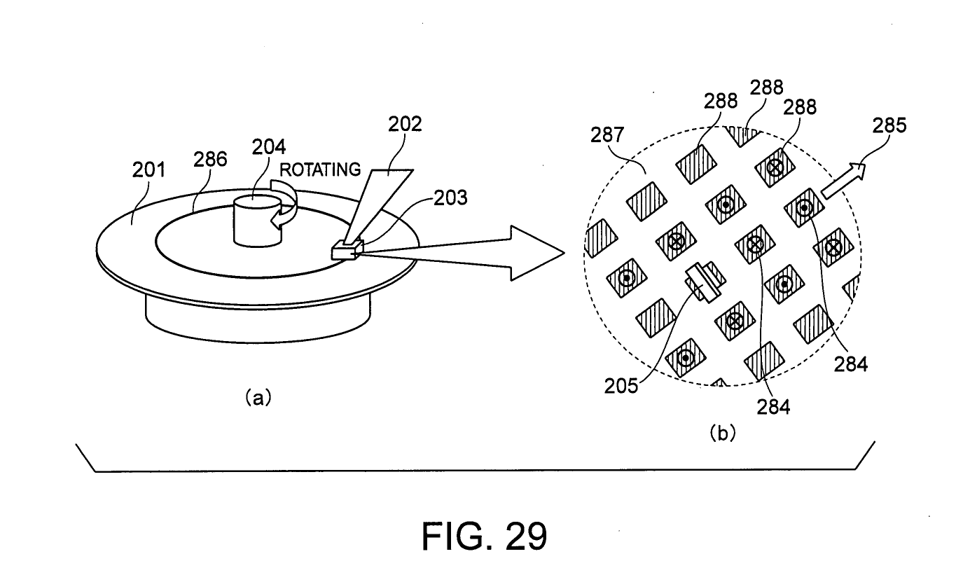

FIGS. 29(a), 29(b) illustrate a second specific example of a magnetic recording medium that can be used with the magnetic head of any of the embodiments of the present invention. The magnetic recording medium 201 of this specific example has magnetic discrete bits 288 that are isolated from one another by nonmagnetic material 287. As the magnetic recording medium 201 is rotated by a spindle motor 204 and is moved in the medium moving direction, recording magnetization 284 is formed by a magnetic head 205 mounted on a head slider 203.

In this specific example, the width (TS) of the spin torque oscillator in the recording track width direction is also made equal to or greater than the recording track width (TW), and equal to or smaller than the recording track pitch (TP), so that the decrease in the coercive force of the adjacent recording tracks due to the leakage high-frequency magnetic field generated from the spin torque oscillator can be greatly reduced. Accordingly, effective high-frequency field assist recording can be performed on the target recording track.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. A magnetic recording head comprising:
a magnetic pole that has a first magnetic portion including an air bearing surface, and generates a write magnetic field; and
a spin torque oscillator that is formed on the air bearing surface of the magnetic pole, and is formed with a stack structure including a first magnetic layer, a second magnetic layer, and a nonmagnetic layer interposed between the first magnetic layer and the second magnetic layer, the second magnetic layer generating a high-frequency magnetic field when current is applied between the first magnetic layer and the second magnetic layer.

2. The head according to claim 1, wherein a projection geometry of the spin torque oscillator projected onto a surface parallel to the air bearing surface has an area smaller than an area of the air bearing surface, and the projection geometry is completely contained in a plane of the air bearing surface.

3. The head according to claim 1, wherein an upper surface of each layer of the spin torque oscillator is substantially parallel to the air bearing surface.

4. The head according to claim 1, wherein a direction in which the first magnetic portion extends is tilted with respect to a direction perpendicular to the air bearing surface.

5. The head according to claim 1, wherein an upper surface of each layer of the spin torque oscillator is substantially perpendicular to the air bearing surface, and an insulating layer is provided between the stack structure and the air bearing surface.

6. The head according to claim 3, wherein the first magnetic layer is included in the magnetic pole, and the nonmagnetic layer is formed directly on the magnetic pole.

7. The head according to claim 1, further comprising a return yoke that has a second magnetic portion substantially parallel to the first magnetic portion of the magnetic pole, and forms a magnetic circuit with the magnetic pole.

8. The head according to claim 7, wherein a first surface of the spin torque oscillator closest to the return yoke is located farther away from the return yoke than a second surface of the first magnetic portion closest to the return yoke, and the distance between the first surface and the second surface is 10 nm or shorter.

9. The head according to claim 8, wherein the second magnetic layer of the stack structure is farther away from the air bearing surface than the first magnetic layer is, and the magnetic recording head further comprises an electrode that is connected to the second magnetic layer.

10. The head according to claim 9, wherein the electrode extends to the return yoke, and is connected to the return yoke.

11. The head according to claim 9, wherein the electrode surrounds a side face of the second magnetic layer.

12. A magnetic recording apparatus comprising:
a magnetic recording medium;
the magnetic recording head according to claim 1;
a reproducing unit that reads a signal recorded on the magnetic recording medium;
a movement control unit that controls the magnetic recording medium, the magnetic recording head, and the reproducing unit to relatively move while the magnetic recording medium faces the magnetic recording head and the reproducing unit in a floating or contact state;
a position control unit that controls the magnetic recording head to be located at a predetermined recording position on the magnetic recording medium; and
a signal processing unit that performs processing on a signal for writing on the magnetic recording medium and a signal for reading from the magnetic recording medium, using the magnetic head.

13. The apparatus according to claim 12, wherein the magnetic recording medium is a discrete track medium that has adjacent recording tracks having a nonmagnetic material interposed in between.

14. The apparatus according to claim 12, wherein the magnetic recording medium is a discrete bit medium that has recording magnetic pattern portions regularly arranged and isolated from one another by a nonmagnetic material.
